(19) United States
(12) Patent Application Publication
(10) Pub. No.: US 2024/0334928 A1
(43) Pub. Date: Oct. 10, 2024

(54) COMPOSITIONS WITH MICROENCAPSULATED ACETAMIDE AND METAL-CHELATED MESOTRIONE

(71) Applicant: MONSANTO TECHNOLOGY LLC, Saint Louis, MO (US)

(72) Inventor: Junhua ZHANG, Chesterfield, MO (US)

(21) Appl. No.: 18/580,076

(22) PCT Filed: Jul. 15, 2022
(86) PCT No.: PCT/US2022/037263

§ 371 Date: Jan. 17, 2024

Related U.S. Application Data
(60) Provisional application No. 63/223,264, filed on Jul. 19, 2021.

(51) Int. Cl. A01N 25/28; A01N 25/04; A01N 37/18; A01N 37/26; A01P 13/00

(52) U.S. Cl. CPC A01N 25/28; A01N 25/04; A01N 37/18; A01N 37/26; A01P 13/00

(57) ABSTRACT

The present invention relates to the technical field of crop protection. The present invention primarily relates to certain aqueous herbicide concentrate compositions comprising (a) at least one particulate microcapsule comprising a water-immiscible core material comprising an acetamide herbicide and a polymeric shell wall containing the core material and (b) a metal-chelate of mesotrione. The present invention also relates to sprayable application mixtures (tank mixes) obtainable by dilution of these herbicide concentrate compositions with water, methods for preparing these concentrate compositions and tank mixes as well as to corresponding methods of using these concentrate compositions and tank mixes for controlling weeds.

### CROSS-REFERFENCE TO RELATED APPLICATIONS

This application claims the benefit of and priority to U.S. Provisional Application Ser. No. 63/223,264, filed Jul. 19, 2021, the entire disclosure of which is hereby incorporated by reference.

### FIELD OF THE INVENTION

The present invention relates to the technical field of crop protection. The present invention primarily relates to certain aqueous herbicide concentrate compositions comprising (a) at least one particulate microcapsule comprising a water-immiscible core material comprising an acetamide herbicide and a polymeric shell wall containing the core material and (b) a metal-chelate of mesotrione. The present invention also relates to sprayable application mixtures (tank mixes) obtainable by dilution of these herbicide concentrate compositions with water, methods for preparing these concentrate compositions and tank mixes as well as to corresponding methods of using these concentrate compositions and tank mixes for controlling weeds.

### BACKGROUND OF THE INVENTION

Herbicide compositions containing a combination of herbicides with multiple modes of action are especially suited for controlling growth of unwanted plants. Further, to enhance the efficiency of applying herbicidal active ingredients, it is highly desirable to combine two or more active ingredients in a single formulation. Compositions containing a combination of active ingredients with different modes of action can provide for greater control of unwanted plants and are beneficial for avoiding or reducing mixing errors when preparing the application mixture in the field. However, the release properties of herbicidal compositions of microencapsulated acetamide herbicides can be sensitive to the inclusion of further additives including co-herbicides. Accordingly, there remains a need for herbicidal compositions containing microencapsulated acetamide herbicides and co-herbicides that are stable over a wide range of conditions and that maintain the controlled release properties of the microencapsulated acetamide herbicide while providing longer weed control, increased crop safety, better compatibility with other tank mixed or premixed formulants, higher loading and improved physio-chemical stability. Additional benefits of co-encapsulation include simplified manufacturing process of making premix comprising multiple active ingredients utilizing a suitable single microencapsulation technology and reduced organic solvent usage.

With regard to herbicides, the emergence of certain herbicide resistant weeds has generated interest in developing strategies to supplement the action of primary herbicides such as glyphosate. Acetamide herbicides are known as effective residual control herbicides that reduce early season weed competition. In particular, acetamide herbicides such as acetochlor provide outstanding residual control of many grasses and broadleaf weeds including pigweed, waterhemp, lambsquarters, nightshade, foxtails, among others. Acetamides are generally classified as seedling growth inhibitors. Seedling growth inhibitors are absorbed and translocated in plants from germination to emergence primarily by subsurface emerging shoots and/or seedling roots. Acetamide herbicides typically do not offer significant post-emergence activity, but as a residual herbicide provide control of newly emerging monocots and small-seeded dicot weed species. This supplements the activity of post-emergent herbicides that lack significant residual activity.

Crop injury caused by application of acetanilide herbicides necessitated strategies to reduce this effect. One strategy involved applying the acetanilide herbicide formulations after the emergence of the crop (i.e., post-emergent to the crop), but before the emergence of later germinating weeds (i.e., pre-emergent to the weeds). However, application during this time window may cause foliar injury to the crop. Other strategies to reduce crop injury involved microencapsulating the acetanilide herbicide. Methods for producing microencapsulated acetanilides are described in various patents and publications.

Acetamide herbicides can be microencapsulated. Methods for producing microencapsulated acetamides are described in various documents including U.S. Pat. No. 5,925,595, US 2004/0137031, US 2005/0277549, US 2010/0248963, US 2013/0029847, WO 2015/113015, WO 2016/112116, WO 2018/231913, WO 2019/143455 and WO 2020/160223. Generally, to form microcapsules, the acetamide herbicide is encapsulated in a polymeric shell wall material. The herbicide is released from the microcapsules at least in part by molecular diffusion through the shell wall.

Acetochlor (2-chloro-N-(ethoxymethyl)-N-(2-ethyl-6-methylphenyl) acetamide) is a known haloacetanilide herbicide (U.S. Pat. No. 3,442,945) and is often abbreviated as ACC.

Mesotrione (2-[4-(methylsulfonyl)-2-nitrobenzoyl] cyclohexane-1,3-dione) is a known herbicide (U.S. Pat. No. 5,006,158) and is often abbreviated as MST.

Auxin herbicides (i.e., synthetic auxin herbicides) have been used in the technical field of crop protection for several decades, and include, for example, 2,4-dichlorophenoxyacetic acid (2,4-D), 4-(2,4-dichlorophenoxy) butyric acid (2,4-DB), 3,6-dichloro-2-methoxybenzoic acid (dicamba), 2-methyl-4-chlorophenoxyacetic acid (MCPA), 4-(4-chloro-2-methylphenoxy) butanoic acid (MCPB).

U.S. Pat. No. 5,741,756 and WO 01/43550 disclose certain mixtures of acetochlor and mesotrione, optionally with further herbicides.

CN 109874790 A pertains to microcapsule suspensions comprising acetochlor and mesotrione.

WO 97/27748 and U.S. Pat. No. 5,912,207 relate to stable herbicidal compositions containing metal chelates of herbicidal dione compounds like mesotrione.

U.S. Pat. No. 6,541,422 discloses a method for improving the selectivity of mesotrione in crops such as wheat by applying a metal chelate of mesotrione, optionally as microcapsule.

U.S. Pat. No. 8,563,471 relates to certain suspension concentrates and suspoemulsion formulations comprising mesotrione having a particle size of less than 1 micron.

WO 2009/103455 pertains to aqueous herbicide formulations comprising (b) an HPPD inhibitor in suspension in the aqueous phase, (b) an encapsulated chloroacetamide and/or an isooxazoline herbicide and (d) glyphosate and/or glufosinate in solution in the aqueous phase.

US 2012/0129694 concerns herbicidal capsule suspensions of acetochlor, optionally comprising a safener.

WO 2012/024524 relates to acetamide herbicide compositions comprising different populations of a particulate microencapsulated acetamide herbicide and optionally a co-herbicide.

WO 2016/112116 suggests certain aqueous herbicide concentrate compositions comprising a polyurea microencapsulated acetamide herbicide and a release modulating agent comprising a polyvalent metal cation, optionally further comprising an auxin co-herbicide. Premixes of microencapsulated acetamide herbicides like acetochlor and an auxin co-herbicide like dicamba are disclosed in WO 2019/143455.

WO 2019/236738 discloses certain oil-in-oil multi-phase compositions which can comprise an acetamide herbicide such as acetochlor and optionally one or more other herbicides such as mesotrione and dicamba.

US 2020/0113180 pertains to a specific crystalline form of a copper chelate of mesotrione.

### BRIEF DESCRIPTION OF THE INVENTION

It was found that certain aqueous herbicide concentrate compositions (also referred herein as herbicide concentrate compositions) comprising microcapsules having a polymeric shell wall and a water-immiscible core material comprising an acetamide herbicide, and a chelate of mesotrione and a divalent transition metal ion—in comparison with other known herbicide concentrates comprising the same active ingredients—exhibit good chemical and physical stability under challenging storage conditions while at the same time exhibiting lower phytotoxicity when applied to useful crops, i.e. their application allows a lower level of crop injury, and to achieve a very similar or even better herbicidal activity against unwanted vegetation (weeds). In addition, the herbicide concentrate compositions of the present invention may comprise one or more further herbicides. If an additional herbicide is present in the water phase of the herbicide concentrate compositions of the present invention, preferably a water-soluble herbicide is present. Said water-soluble herbicide then preferably is an auxin herbicide such as dicamba or 2,4-D, and the herbicide concentrate compositions preferably additionally comprise a volatility control agent. If an additional herbicide is present in the water-immiscible core material of the microcapsules comprised in the herbicide concentrate compositions of the present invention, said additional herbicide preferably is diflufenican.

Among the several features of the invention, it may be noted that the aqueous herbicide concentrate compositions of the present invention are useful in agriculture wherein multiple active ingredients are co-formulated to achieve good or increased stability properties, higher weed control and/or increased crop compatibility.

Briefly, aspects of the present invention are directed to certain herbicide concentrate compositions comprising (a) at least one microcapsule comprising a polymeric shell wall, and a water-immiscible core material comprising an acetamide herbicide, (b) a chelate of mesotrione and a divalent transition metal ion, wherein the molar ratio of the total amount of mesotrione and the total amount of the divalent transition metal ions expressed as molar ratio of mesotrione: divalent transition metal ions is greater than 2:1, and (c) water.

The herbicide concentrate compositions preferably are ZC formulations and may comprise one or more further herbicides, either in the water-immiscible core of the microcapsules and/or the aqueous phase of the herbicide concentrate compositions.

In order to inter alia achieve the desired properties of the herbicide concentrate compositions, the microcapsules used in the context of the present invention are preferably characterized as having a mean particle size range of from about 2 μm to about 15 μm, and/or the chelate of mesotrione and a divalent transition metal ion is present in solid form, wherein preferably these solid particles have an average particle size of from about 2 μm to about 12 μm.

Other aspects of the present invention are directed to spray application mixtures obtainable or obtained by diluting the herbicide concentrate compositions.

Further aspects of the present invention are directed to methods for controlling weeds in a field of a crop plant, the method comprising applying to said field the herbicide concentrate composition or a spray application mixture.

### DETAILED DESCRIPTION

Generally, the present invention relates to herbicide concentrate compositions comprising (a) at least one particulate microcapsule comprising a polymeric shell wall, and a water-immiscible core material comprising (i) an acetamide herbicide and (ii) optionally one or more organic non-polar diluents, wherein the total weight of the (i) acetamide herbicide is least about 5 wt. % of the total weight of the microcapsule, (b) a chelate of mesotrione and a divalent transition metal ion, wherein the molar ratio of the total amount of mesotrione and the total amount of the divalent transition metal ions expressed as molar ratio of mesotrione: divalent transition metal ions is greater than 2:1 (i.e. less than 100% of the amount of mesotrione present in the herbicide concentrate composition is chelated), (c) water, wherein the pH-value of the herbicide concentrate composition preferably is about 4.5 or lower at 25° C. and 1013 mbar.

The aqueous herbicide concentrate compositions of the present invention preferably are in the form of a ZC formulation. The formulation code ZC is used and known in the art. A ZC formulation is a mixed formulation of CS (capsule suspension) and SC (suspension concentrate) and is a stable aqueous suspension of microcapsules and solid fine particles, each of containing one or more active ingredients. The formulation is intended for dilution into water prior to spray application.

Further aspects of the invention are directed to (spray) application mixtures prepared from or obtainable from the herbicide concentrate compositions of the present invention and to methods of using these compositions for controlling weeds.

### Microencapsulation

As noted, microcapsules used in the context of the present invention comprise a core material comprising the acetamide and a shell wall containing the core material. The process of microencapsulation can be conducted according to known (interfacial polycondensation) techniques. Microencapsulation of water-immiscible materials utilizing an interfacial polycondensation reaction generally involves dissolving a first reactive monomeric or polymeric material(s) (first shell wall component) in the material to be encapsulated to form the oil or discontinuous phase liquid. The discontinuous phase liquid is then dispersed into an aqueous or continuous phase liquid to form an oil-in-water emulsion. The continuous phase (aqueous) liquid may contain a second reactive monomeric or polymeric material (second shell wall component) at the time the discontinuous phase is dispersed into the continuous phase. If this is the case, the first and second shell wall components will immediately begin to react at the oil-in-water interface to form a polycondensate shell wall around the material to be encapsulated. However, the oil-in-water emulsion can also be formed before the second shell wall component is added to the emulsion.

Microcapsules comprising acetamides that are suitable to be used in the context of the present invention are known in the art and methods for producing such microcapsules described in various documents including U.S. Pat. No. 5,925,595, US 2004/0137031, US 2005/0277549, US 2010/0248963, US 2013/0029847, WO 2015/113015, WO 2016/112116, WO 2018/231913, WO 2019/143455 and WO 2020/160223.

### Polymeric Shell Wall

In one aspect, the polymeric shell wall comprises or consists of organic polymers, preferably selected from the group consisting of polyurea, polyurethane, polycarbonate, polyamide, polyester and polysulfonamide, and mixtures thereof.

In the following, features, properties and characteristics of preferred microcapsules used according to the present invention are described, in particular microcapsules wherein the polymeric shell wall is a polyurea shell wall.

Microcapsules according to the present invention wherein the polymeric shell wall is a polyurea shell wall are preferably formed in a polymerization medium by a polymerization reaction between a polyisocyanate component comprising a polyisocyanate or mixture of polyisocyanates and a polyamine component comprising a polyamine or mixture of polyamines to form the polyurea.

In a preferred microcapsule according to the present invention the polyisocyanate component comprises an aliphatic polyisocyanate.

In a preferred microcapsule according to the present invention the polyamine component comprises a polyamine of the structure NH₂(CH₂CH₂NH)ₘCH₂CH₂NH₂ where m is from 1 to 5, 1 to 3, or 2.

In a preferred microcapsule according to the present invention the polyamine component is selected from the group consisting of substituted or unsubstituted polyethyleneamine, polypropyleneamine, diethylene triamine, triethylenetetramine (TETA), and combinations thereof, preferably the polyamine component is triethylenetetramine (TETA).

In a preferred microcapsule according to the present invention the ratio of amine molar equivalents contained in the polyamine component to isocyanate molar equivalents contained in the polyisocyanate component is at least about 0.9:1, at least about 0.95:1, at least about 1:1, at least about 1.01:1, at least about 1.05:1, or at least about 1.1:1.

In a preferred microcapsule according to the present invention the polyurea shell wall is formed in a polymerization medium by a polymerization reaction between a polyisocyanate component comprising a polyisocyanate or mixture of polyisocyanates and a polyamine component comprising a polyamine or mixture of polyamines to form the polyurea and the ratio of amine molar equivalents contained in the polyamine component to isocyanate molar equivalents contained in the polyisocyanate component is from about from 1.01:1 to about 1.3:1, preferably from 1.01:1 to about 1.25:1, from 1.01:1 to about 1.2:1, from about 1.05:1 to about 1.3:1, from about 1.05:1 to about 1.25:1, from about 1.05:1 to about 1.2:1, from about 1.1:1 to about 1.3:1, from about 1.1:1 to about 1.25:1, and from about 1.1:1 to about 1.2:1.

The water-immiscible core material of the microcapsules used in the context of the present invention comprising the acetamide herbicide is encapsulated with a polymeric shell wall, preferably a polyurea shell wall. In general, the polyurea shell wall is formed in a polymerization medium by a polymerization reaction between a polyisocyanate component comprising a polyisocyanate or mixture of polyisocyanates and a polyamine component comprising a polyamine or mixture of polyamines to form the polyurea. See, for example, U.S. Pat. No. 5,925,595, US 2004/0137031, US 2005/0277549, US 2010/0248963, US 2013/0029847, WO 2016/112116, WO 2018/231913 and WO 2019/143455.

The polyurea shell wall of the microcapsules used in the context of the present invention can be prepared by contacting an aqueous continuous phase containing a polyamine component comprising a polyamine source and a discontinuous oil phase containing the acetamide herbicide and a polyisocyanate component comprising a polyisocyanate source. A polyurea shell wall is formed in a polymerization reaction between the polyamine source and the isocyanate source at the oil/water interface thereby forming a microcapsule containing the acetamide herbicide.

The polyurea polymer shell wall of the microcapsules may be formed using one or more polyisocyanates, i.e., having two or more isocyanate groups per molecule. A wide variety of polyisocyanates can be employed. For example, the polyisocyanate component can comprise an aliphatic polyisocyanate (e.g., DESMODUR W, DESMODUR N 3200 and DESMODUR N 3215). In some embodiments, the polyurea shell wall is formed using a blend of at least two polyisocyanates. For example, the polyurea shell wall is formed in an interfacial polymerization reaction using at least one diisocyanate and at least one triisocyanate (e.g., a combination of DESMODUR W and DESMODUR N 3200 or N 3215).

The polyamine source can be a single polyamine species or a mixture of two or more different polyamine species. In some embodiments of the present invention, the polyamine source consists essentially of a principal polyamine. As used herein, a principal polyamine refers to a polyamine consisting essentially of a single polyamine species.

It is advantageous to select a polyamine component and a polyisocyanate component such that the polyamine has an amine functionality of at least 2, i.e., 3, 4, 5 or more, and at least one of the polyisocyanates has an isocyanate functionality of at least 2, i.e., 2.5, 3, 4, 5, or more since high amine and isocyanate functionality increases the percentage of cross-linking occurring between individual polyurea polymers that comprise the shell wall. In some embodiments, the polyamine has an amine functionality of greater than 2 and the polyisocyanate is a mixture of polyisocyanates wherein each polyisocyanate has an isocyanate functionality of greater than 2. In other embodiments. the polyamine comprises a trifunctional polyamine and the polyisocyanate component comprises one or more trifunctional polyisocyanates. In yet other embodiments, the shell wall is formed by the reaction between a polyisocyanate or mixture of polyisocyanates with a minimum average of 2.5 reactive groups per molecule and a polyamine with an average of at least three reactive groups per molecule. It is, moreover, advantageous to select concentrations of the polyamine component and the polyisocyanate component such that the polyisocyanate component is substantially completely reacted to form the polyurea polymer. Complete reaction of the polyisocyanate component increases the percentage of cross-linking between polyurea polymers formed in the reaction thereby providing structural stability to the shell wall.

As described, the oil-in-water emulsion that is formed during the interfacial polymerization reaction can be prepared by adding the oil phase to the continuous aqueous phase to which an emulsifying agent (emulsifier) has been added (e.g., previously dissolved therein). The emulsifying agent is selected to achieve the desired oil droplet size in the emulsion. The size of the oil droplets in the emulsion is influenced by a number of factors in addition to the emulsifying agent employed and determines the size of microcapsules formed by the process. The emulsifying agent is preferably a protective colloid. Polymeric dispersants are preferred as protective colloids. Polymeric dispersants provide steric stabilization to an emulsion by adsorbing to the surface of an oil drop and forming a high viscosity layer which prevents drops from coalescing. Polymeric dispersants may be surfactants and are preferred to surfactants which are not polymeric, because polymeric compounds form a stronger interfacial film around the oil drops. If the protective colloid is ionic, the layer formed around each oil drop will also serve to electrostatically prevent drops from coalescing.

Preferred emulsifying agents in the context of the present invention are lignin sulfonates, e.g. REAX® 105M=Highly sulfonated, low molecular weight sodium salt of kraft lignosulfonate dispersant with a low free electrolyte content (available from Ingevity), maleic acid-olefin copolymers, e.g. SOKALAN (available from BASF), and naphthalene sulfonate condensates, e.g. INVALON (available from Huntsman) and AGNIQUE NSC 11NP (available from BASF).

Further, it is preferred to add glycerin in the aqueous (i.e. external) phase to balance the density difference between the microcapsules and the continuous aqueous phase in which these capsules are suspended, making the formulation physically stable. Further, glycerin is an anti-freezing agent, thereby preventing formulations becoming frozen at low temperatures. Glycerin dissolves in water and is not included in the microcapsules obtained.

In various embodiments, the microencapsulation method includes encapsulating core material in a shell wall formed by reacting a polyamine component and a polyisocyanate component in a reaction medium in concentrations such that the reaction medium comprises a molar equivalent excess of amine groups compared to the isocyanate groups. That is, the molar equivalents ratio of amine equivalents to isocyanate equivalents used in preparation of the shell wall of the microcapsules is equal to or greater than about 1:1. For example, a molar equivalents ratio at least 1.01:1, or at least about 1.05:1, or at least about 1.1:1 is used to ensure that the isocyanate is completely reacted. The ratio of amine molar equivalents contained in the polyamine component to isocyanate molar equivalents contained in the polyisocyanate component can be from 1.01:1 to about 1.3:1, preferably from 1.01:1 to about 1.25:1, from 1.01:1 to about 1.2:1, from about 1.05:1 to about 1.3:1, from about 1.05:1 to about 1.25:1, from about 1.05:1 to about 1.2:1, from about 1.1:1 to about 1.3:1, from about 1.1:1 to about 1.25:1, and from about 1.1:1 to about 1.2:1.

The molar equivalents ratio of amine molar equivalents to isocyanate molar equivalents is calculated according to the following equation:

$$Molar Equivalents Ratio = \frac{amine molar equivalents}{isocyanate molar equivalents} \qquad ( 1 )$$

In the above equation (1), the amine molar equivalents is calculated according to the following equation:

molar equivalents=Σ(polyamine weight/equivalent weight).

In the above equation (1), the isocyanate molar equivalents is calculated according to the following equation:

isocyanate molar equivalents=Σ(polyisocyanate weight/equivalent weight).

The equivalent weight is generally calculated by dividing the molecular weight in grams/mole by the number of functional groups per molecules and is in grams/mole. For some molecules, such as triethylenetetramine (“TETA”) and 4,4′-diisocyanato-dicyclohexyl methane (“DES W”), the equivalent weight is equal to the molecular weight divided by the number of functional groups per molecule. For example, TETA has a molecular weight of 146.23 g/mole and 4 amine groups. Therefore, the equivalent weight is 36.6 g/mol. This calculation is generally correct, but for some materials, the actual equivalent weight may vary from the calculated equivalent weight. In some components, for example, the biuret-containing adduct (i.e., trimer) of hexamethylene-1,6-diisocyanate, the equivalent weight of the commercially available material differs from the theoretical equivalent weight due to, for example, incomplete reaction. The theoretical equivalent weight of the biuret-containing adduct (i.e., trimer) of hexamethylene-1,6-diisocyanate is 159.5 g/mol. The actual equivalent weight of the trimer of hexamethylene-1,6-diisocyanate (“DES N3200”), the commercially available product, is about 183 g/mol. This actual equivalent weight is used in the calculations above. The actual equivalent weight may be obtained from the manufacturer or by titration with a suitable reactant by methods known in the art. The symbol, Σ, in the amine molar equivalents calculation means that the amine molar equivalents comprises the sum of amine molar equivalents for all polyamines in the reaction medium. Likewise, the symbol, Σ, in the isocyanate molar equivalents calculation means that the isocyanate molar equivalents comprises the sum of isocyanate molar equivalents for all polyisocyanates in the reaction medium.

In general, the water-immiscible core material of the microcapsules is encapsulated by a polyurea shell wall, which is preferably substantially non-microporous, such that core material release occurs by a molecular diffusion mechanism, as opposed to a flow mechanism through a pore or rift in the polyurea shell wall. As noted herein, the shell wall may preferably comprise a polyurea product of a polymerization of one or more polyisocyanates and a principal polyamine (and optional auxiliary polyamine).

Generally, the microcapsules can be characterized as having a mean particle size of at least about 2, 3, 4, 5, 6, 7, 8, 9 or 10 μm. For example, the microcapsules used in the context of the present invention typically have a mean particle size range of from about 2 μm to about 15 μm, from about 2 μm to about 12 μm, from about 2 μm to about 10 μm, from about 2 μm to about 8 μm, from about 3 μm to about 15 μm, from about 3 μm to about 10 μm, from about 3 μm to about 8 μm, from about 4 μm to about 15 μm, from about 4 μm to about 12 μm, from about 4 μm to about 10 μm, from about 4 μm to about 8 μm, or from about 4 μm to about 7 μm. Preferably, microcapsules are characterized as having a mean particle size range of from about 3 μm to about 9 μm. The microcapsules are essentially spherical such that the mean transverse dimension defined by any point on a surface of the microcapsule to a point on the opposite side of the microcapsule is essentially the diameter of the microcapsule. The mean particle size of the microcapsules can be determined by measuring the particle size of a representative sample with a laser light scattering particle size analyzer known to those skilled in the art. One example of a particle size analyzer is a Coulter LS Particle Size Analyzer.

### Water-immiscible Core Material of the Microcapsules

The microcapsules used in the context of the present invention comprise a water-immiscible core material comprising at least (i) an acetamide herbicide, (ii) optionally one or more organic non-polar diluents and (iii) optionally one or more other herbicides. In addition, other herbicidal active ingredients and/or safeners, can be incorporated into and be part of the water-immiscible core material of said microcapsules.

In microcapsules present in the herbicide concentrate compositions of the present invention, the total weight of (i) acetamide herbicide typically is at least about 10 wt. %, preferably at least about 15 wt. %, more preferably at least about 20 wt. %, even more preferably at least about 25 wt. %, and particularly preferably at least about 30 wt. %, in each case based on the total weight of the microcapsule of constituent (a).

Preferably, in the herbicide concentrate compositions of the present invention, the total weight of the (i) acetamide herbicide is from about 10 wt. % to about 15 wt. %, from about 15 wt. % to about 20 wt. %, from about 20 wt. % to about 25 wt. %, from about 25 wt. % to about 30 wt. %, from about 30 wt. % to about 35 wt. %, from about 35 wt. % to about 40 wt. %, or from about 40 wt. % to about 45 wt. % of the microcapsules of constituent (a).

Preferably, in the herbicide concentrate compositions of the present invention, the total weight of the (i) acetamide herbicide is at least about 10 wt. %, preferably at least about 15 wt. %, more preferably at least about 20 wt. %, in each case based on the total weight of the composition.

Preferably, in the herbicide concentrate compositions of the present invention, the total weight of the (i) acetamide herbicide is in the range of from about 10.0 wt. % to about 35.0 wt. %, preferably in the range of from about 15.0 wt. % to about 30.0 wt. %, more preferably in the range of from about 20.0 wt. % to about 27.5 wt. %, in each case based on the total weight of the composition.

The acetamide herbicide present in the water-immiscible core material of the microcapsules used in the context of the present invention preferably comprises at least one herbicide selected from the group consisting of acetochlor, alachlor, butachlor, butenachlor, delachlor, diethatyl and agriculturally acceptable esters thereof, dimethachlor, dimethenamid, dimethenamid-P, mefenacet, metazachlor, metolachlor, S-metolachlor, napropamide, pretilachlor, pronamide, propachlor, propisochlor, prynachlor, terbuchlor, thenylchlor and xylachlor, or agriculturally acceptable esters thereof, and combinations thereof.

In various embodiments, the acetamide herbicide is selected from the group consisting of acetochlor, alachlor, metolachlor, S-metolachlor, dimethenamid, dimethenamid-P, butachlor, and combinations thereof.

In certain embodiments, the acetamide herbicide is selected from the group consisting of acetochlor, metolachlor and S-metolachlor. In some embodiments, the acetamide herbicide comprises or consists of acetochlor.

The acetamide herbicide containing microcapsules can be produced according to methods that are described in various documents including U.S. Pat. No. 5,925,595, US 2004/0137031, US 2005/0277549, US 2010/0248963, US 2013/0029847, WO 2015/113015, WO 2016/112116, WO 2018/231913, WO 2019/143455 and WO 2020/160223.

Particularly suitable for the aqueous herbicide concentrate compositions of the present invention having a pH-value of about 4.0 or in the range of from 3.2 to 4.0 are the acetamide herbicide containing microcapsules described in WO 2019/143455 and WO 2020/160223.

The core material of the microcapsule used in the herbicide concentrate compositions of the present invention may optionally comprise (ii) one or more organic non-polar diluents.

The core material of the microcapsule used in the context of the present invention may comprises (ii) one or more organic non-polar diluents selected from the group of organic non-polar diluent that are miscible with the acetamide herbicide of constituent (i) and form a one-phase liquid mixture at 25° C. and 1013 mbar.

A diluent, such as a solvent, may be added to change the solubility parameter characteristics of the core material to increase or decrease the release rate of the herbicides from the microcapsule once release has been initiated. In some embodiments, the diluent is a water-insoluble organic solvent having a solubility of less than about 10, less than about 5, less than about 1, less than about 0.5 or even less than about 0.1 gram per liter at 25°° C. and 1013 mbar.

Exemplary diluents include, for example: alkyl-substituted biphenyl compounds (e.g., SureSol 370, commercially available from Koch Co.); normal paraffin oil (e.g., NORPAR 15, commercially available from Exxon); mineral oil (e.g., ORCHEX 629, commercially available from Exxon); isoparaffin oils (e.g., ISOPAR V and ISOPAR L. commercially available from Exxon); aliphatic fluids or oils (e.g., EXXSOL D110 and EXXSOL D130, commercially available from Exxon); alkyl acetates (e.g., EXXATE 1000, formerly commercially available from Exxon); aromatic fluids or oils (A 200, commercially available from Exxon); citrate esters (e.g., Citroflex A4, commercially available from Morflex); and, plasticizing fluids or oils used in, for examples, plastics (typically high boiling point esters). In some embodiments, the diluent comprises a paraffinic hydrocarbon solvent, preferably containing predominantly a linear or branched hydrocarbon such as pentadecane, ISOPAR V, and ISOPAR M. In some embodiments the diluent is selected from the group consisting of paraffin oil, isoparaffin oil, aliphatic fluids or oils, aromatic hydrocarbon solvents, and combinations thereof.

Preferred organic non-polar diluents of constituent (ii) of a microcapsule used in the context of the present invention are preferably selected from the group consisting of paraffin oil, isoparaffin oil, aliphatic fluids or oils, aromatic hydrocarbons, fatty acid dimethylamides, fatty acid esters, and mixtures thereof.

If the core material of the microcapsule comprises (ii) one or more organic non-polar diluents, the ratio by weight of the total weight of the (i) acetamide herbicide to the total weight of the (ii) organic non-polar diluents in said microcapsule is in the range of from in the range of from 100:1 to 1:10, preferably 100:1 to 1:1, more preferably in the range of from 50:1 to 2:1.

If said additional herbicide (iii) is not readily soluble in the core material of the microcapsule to form a homogenous phase, such as diflufenican, certain organic non-polar solvents are preferably used to form the internal phase and be part of water-immiscible core material of microcapsules used according to the present invention. In such a case, the (ii) organic non-polar solvents are preferably selected from the group consisting of aromatic hydrocarbons, e.g. toluene, xylene, tetrahydronaphthalene, alkylated naphthalenes, fatty acid dimethylamides, and fatty acid esters, and mixtures thereof. Fatty acids in the context of the present invention are C₆-C₁₈ fatty acids (i.e. fatty acids with 6 to 18 carbon atoms), preferably C₈-C₁₂ fatty acids (i.e. fatty acids with 8 to 12 carbon atoms).

In a preferred microcapsule used in the context of the present invention the (ii) organic non-polar solvent comprises or consists of aromatic hydrocarbons, fatty acid dimethylamides, and mixtures thereof.

Preferably. such aromatic hydrocarbons have 10 to 16 carbon atoms (C₁₀-C₁₆), preferably with a distillation range 232-278° C. (like Aromatic 200 or Aromatic 200 ND from ExxonMobil). Aromatic 200 ND [Solvent Naphtha (petroleum), Heavy Aromatic], is a complex mixture of aromatic hydrocarbons, the main components thereof (typically about 50-85 wt.-%) are aromatic hydrocarbons (C₁₁-C₁₄) including 1-methylnaphthalene and 2-methylnaphthalene, as well as aromatic hydrocarbons (C₁₀), including naphthalene, and aromatic hydrocarbons (C₁₅-C₁₆), the total amount of aromatic hydrocarbons being >99 wt. %.

Preferably, such fatty acid dimethylamides are N,N-dimethyloctanamide N,N-dimethyldecanamide, and mixtures thereof (with the brand name of Armid DM 810 from AkzoNobel or Steposol M-8-10 from Stepan).

The total weight of the (ii) organic non-polar solvent in such a case preferably is from about 5 wt. % to about 8 wt. %, from about 8 wt. % to about 11 wt. %, from about 11 wt. % to about 14 wt. %, from about 14 wt. % to about 17 wt. %, or from about 17 wt. % to about 20 wt. %, in each case based on the total weight of the microcapsule.

### Mesotrione and Divalent Metal Chelated Mesotrione (Constituent (b))

As mentioned above, Mesotrione (2-[4-(methylsulfonyl)-2-nitrobenzoyl]cyclohexane-1,3-dione) is a known and commercially available herbicide.

Mesotrione is present in the aqueous herbicide concentrate compositions of the present invention chelated by the divalent transition metal ions to an extent of less than 100 mol %. Thus, the molar ratio of the total amount of mesotrione and the total amount of the divalent transition metal ions expressed as molar ratio of mesotrione: divalent transition metal ions is >2:1, i.e. higher (greater) than 2:1.

The divalent transition metal chelated mesotrione typically is present in the form of solid particles suspended in the water phase of the aqueous herbicide concentrate compositions.

Preferably, the molar ratio of the total amount of mesotrione and the total amount of the divalent transition metal ions expressed as molar ratio of mesotrione:divalent transition metal ions is in the range of from about 5:2 to about 8:2, preferably in the range of from about 5:2 to about 7:2, more in the range of from about 5:2 to about 6:2, and even more preferably about 2:0.75, in each case based on the total weight of the herbicide concentrate composition.

Preferably, the total weight of mesotrione on an acid equivalent (ae) basis is from about 1.0 wt. % to about 5.0 wt. %, preferably from about 1.5 wt. % to about 4.5 wt. %, more preferably from about 1.75 wt. % to about 4.0 wt. %, even more preferably from about 2.0 wt. % to about 3.5 wt. %, in each case based on the total weight of the herbicide concentrate composition.

In preferred embodiments of the present invention, the ratio of the total weight of acetamide herbicides to the total weight of mesotrione on an acid equivalent (ae) basis, is in the range of from about 3:1 to about 20:1, preferably in the range of from about 4:1 to about 17:1, more preferably in the range of from about 5:1 to about 15:1, often in the range of from about 6:1 to about 12:1, such as about 10:1, in each case based on the total weight of the herbicide concentrate composition.

Any appropriate salt which would be a source of the divalent transition metal ion may be used to form the metal chelate of mesotrione in the context of this invention. Particularly suitable salts include: chlorides, sulfates, nitrates, carbonates, phosphates and acetates. The salt of the divalent transition metal ion used typically is water-soluble to an extent sufficient to dissolve in water to form the respective mesotrione chelate.

The divalent transition metal ions are preferably Cu²⁺, Co²⁺, Ni²⁺ or Zn²⁺, especially divalent copper ions (Cu²⁺). Particularly preferably, the divalent copper ions (Cu²⁺) forming the mesotrione chelate are used in the form of Cu(II) sulfate such as Copper sulfate pentahydrate CuSO₄·5H₂O.

Typically, mesotrione chelated by a divalent transition metal ion is present in the herbicide concentrate compositions of this invention in solid form, wherein preferably the solid particles have an average particle size of from about 2 μm to about 12 μm, preferably of from about 3 μm to about 10 μm, more preferably of from about 4 μm to about 9 μm, particularly preferably of from about 5 μm to about 8 μm.

The mesotrione chelated by the divalent transition metal ions used in the context of the present invention can be prepared according to methods known in the art and described in the prior art documents such as those mentioned above, for example as described in WO 97/27748. Mesotrione chelated by the divalent transition metal ions can be produced separately and be mixed with the other constituents forming the herbicide concentrate compositions of the present invention.

According to one process useful in the context of the present invention, the mesotrione is milled and then added to the aqueous phase of a mixture having microcapsules used in the context of the present invention suspended in the aqueous phase. Subsequently, an aqueous solution of an appropriate salt of the divalent transition metal ions is added to said mixture to allow to react at room temperature for a period of time sufficient to convert mesotrione to its corresponding divalent transition metal chelate. The pH-value of the resulting mixture typically is then adjusted a pH-value in a (preferred, more preferred or particularly preferred) range indicated in the context of the present invention, using an appropriate acid.

According to another process useful in the context of the present invention, the mesotrione need not be milled prior to formation of the divalent transition metal chelate. In this process, the mesotrione is added to the aqueous phase of a mixture having microcapsules used in the context of the present invention suspended therein. The pH-value of the resultant mixture is then adjusted to about 10, using sodium hydroxide or another base. An aqueous solution of an appropriate divalent transition metal salt is then added to the mixture with stirring and crystals of the divalent transition metal chelate of mesotrione form instantly. The reaction is allowed to proceed until mesotrione is converted to its corresponding divalent transition metal chelate. Finally, the pH-value of the resulting mixture typically is then adjusted a pH-value in a (preferred, more preferred or particularly preferred) range indicated in the context of the present invention, using an appropriate acid.

Also, a more process-efficient, cost-effective, flexible and simplified method of obtaining mesotrione chelated by the divalent transition metal ions suitable as constituent (b) of the aqueous herbicide concentrate compositions of the present invention has been found.

Thus, in a further aspect, the present invention relates to a method of

manufacturing a herbicide concentrate composition according to the present invention, wherein said method comprises the following steps:

(1) providing

(a) at least one particulate microcapsule comprising

a polymeric shell wall, and

a water-immiscible core material comprising (i) an acetamide herbicide and (ii) optionally one or more organic non-polar diluents,

wherein the total weight of the (i) acetamide herbicide is least about 5 wt. % of the total weight of the microcapsule,

(b-1) mesotrione solid particles have an average particle size of from about 2 μm to about 12 μm, preferably of from about 3 μm to about 10 μm, more preferably of from about 4 μm to about 9 μm, particularly preferably of from about 5 μm to about 8 μm,

(b-2) a salt of divalent transition metal ion,

wherein the molar ratio of the total amount of mesotrione and the total amount of the divalent transition metal ion salt as molar ratio of mesotrione:divalent transition metal ions is greater than 2:1,

(c) water,

(2) mixing the constituents provided in step (1).

In said method the salt of divalent transition metal ion of constituent (b-2) preferably is a water-soluble salt, preferably a water-soluble Cu (II)-salt, preferably Cu (II) sulfate, in turn preferably in form of CuSO_{4.5}H₂O.

Water (Constituent (c)) and pH-value of the Herbicide Concentrate Compositions

Water (constituent (c)) is present in the herbicide concentrate compositions of the present invention in the range of from about 20 wt. % to about 80 wt. %, preferably in the range of from about 30 wt. % to about 60 wt. %, in each case based on the total weight of the composition.

The pH-value of the aqueous herbicide concentrate compositions of the present invention typically is 4.5 or lower, preferably in the range of from about 3.2 to about 4.2, more preferably in the range of from about 3.4 to about 4.0, in each case when measured at 25° C. and 1013 mbar. The pH-value of the herbicide concentrate compositions of the present invention often is in the range of from about 3.4 to about 3.8 when measured at 25° C. and 1013 mbar.

The pH-values indicated herein, such as the pH-values of the herbicide concentrate compositions of the present invention, were measured using conventional pH measuring equipment, preferably by immersing the probe of a pH meter into a sample of the composition. Prior to measuring pH of the composition, the pH meter was calibrated in accordance with the manufacturer's recommended protocol.

### Further Pesticides and Safeners Optionally Present in the Microcapsules or the Herbicide Concentrate Compositions of the Present Invention

The microcapsules used in the context of the present invention and/or the aqueous herbicide concentrate compositions of the present invention can comprise further pesticides and/or safeners in addition to constituents (a) and (b) as defined in the context of the herbicide concentrate compositions of the present invention. Depending on the solubility properties of the further pesticides and/or safeners optionally used, the further pesticides and/or safeners may be incorporated into the core of the microcapsules used in the context of the present invention in case they are water-insoluble or water-immiscible, or the further pesticides and/or safeners may be incorporated into the water phase (constituent (c) of herbicide concentrate compositions of the present invention) comprising the dispersed microcapsules used in the context of the present invention and be dissolved or dispersed therein in case the further pesticides and/or safeners are water-soluble or water-miscible.

Further pesticides and safeners optionally incorporated into microcapsules used in the context of the present invention or into the water phase of the aqueous herbicide concentrate compositions of the present invention and the common names used herein are known in the art, see, for example, “The Pesticide Manual” 16^{th} Edition, British Crop Protection Council 2012; these include the known stereoisomers (in particular racemic and enantiomeric pure isomers) and derivatives such as salts or esters, and particularly the commercially customary forms. Where a pesticide, in particular an herbicide, is referenced generically herein by name, unless otherwise restricted, that pesticide includes all commercially available forms known in the art such as salts, esters, free acids and free bases, as well as stereoisomers thereof. For example, where the herbicide name “glyphosate” is used, glyphosate acid, salts and esters are within the scope thereof.

The further pesticides preferably comprise or are further herbicides. In these and other embodiments, the one or more further herbicides can be selected from the group consisting of acetyl CoA carboxylase (ACCase) inhibitors, enolpyruvyl shikimate-3-phosphate synthase (EPSPS) inhibitors, glutamine synthetase inhibitors, auxins, photosystem I (PS I) inhibitors, photosystem II (PS II) inhibitors, acetolactate synthase (ALS) or acetohydroxy acid synthase (AHAS) inhibitors, mitosis inhibitors, protoporphyrinogen oxidase (PPO) inhibitors, 4-Hydroxyphenylpyruvate dioxygenase (HPPD) inhibitors, cellulose inhibitors, oxidative phosphorylation uncouplers, dihydropteroate synthase inhibitors, fatty acid and lipid biosynthesis inhibitors, auxin transport inhibitors and carotenoid biosynthesis inhibitors, salts and esters thereof. racemic mixtures and resolved isomers thereof, and mixtures thereof.

Safeners in the context of the present invention are herbicide safeners. Preferably, safeners are selected from the group consisting of benoxacor, cloquintocet and agriculturally acceptable esters thereof, cyometrinil, cyprosulfamide, dichlormid, dicyclonon, dietholate, fenchlorazole and agriculturally acceptable esters thereof, fenclorim, flurazole, fluxofenim, furilazole, isoxadifen and agriculturally acceptable esters thereof, mefenpyr and agriculturally acceptable esters thereof, mephenate, metcamifen, naphthalic anhydride, oxabetrinil, and mixtures thereof. More preferably, the herbicide safener is selected from the group consisting of benoxacor, cloquintocet-methyl, cloquintocet-mexyl, cyprosulfamide, fenchlorazole-ethyl, furilazole, isoxadifen-ethyl and mefenpyr-diethyl.

EPSPS herbicides include glyphosate or a salt or ester thereof.

Glutamine synthetase herbicides include glufosinate or glufosinate-P, or a salt or and ester thereof.

ACCase inhibitors include, for example, alloxydim, butroxydim, clethodim, cycloxydim, pinoxaden, sethoxydim, tepraloxydim and tralkoxydim, salts and esters thereof, and mixtures thereof. Another group of ACCase inhibitors include chlorazifop, clodinafop, clofop, cyhalofop, diclofop, diclofop-methyl, fenoxaprop, fenthiaprop, fluazifop, haloxyfop, isoxapyrifop, metamifop, propaquizafop, quizalofop and trifop, salts and esters thereof, and mixtures thereof. ACCase inhibitors also include mixtures of one or more “dims” and one or more “fops”, salts and esters thereof.

Auxin herbicides (i.e., synthetic auxin herbicides) include, for example, 2,4-dichlorophenoxyacetic acid (2,4-D), 4-(2,4-dichlorophenoxy) butyric acid (2,4-DB), dichloroprop, 2-methyl-4-chlorophenoxyacetic acid (MCPA), 4-(4-chloro-2-methylphenoxy) butanoic acid (MCPB), aminopyralid, clopyralid, fluroxypyr, triclopyr, diclopyr, mecoprop, dicamba, picloram, quinclorac, benazolin, halauxifen, fluorpyrauxifen, methyl 4-amino-3-chloro-5-fluoro-6-(7-fluoro-1H-indol-6-yl) pyridine-2-carboxylate, 4-amino-3-chloro-5-fluoro-6-(7-fluoro-1H-indol-6-yl) pyridine-2-carboxylic acid, benzyl 4-amino-3-chloro-5-fluoro-6-(7-fluoro-1H-indol-6-yl) pyridine-2-carboxylate, methyl 4-amino-3-chloro-5-fluoro-6-(7-fluoro-1-isobutyryl-1H-indol-6-yl) pyridine-2-carboxylate, methyl 4-amino-3-chloro-6-[1-(2,2-dimethylpropanoyl)-7-fluoro-1H-indol-6-yl]-5-fluoropyridine-2-carboxylate, methyl 4-amino-3-chloro-5-fluoro-6-[7-fluoro-1-(methoxyacetyl)-1H-indol-6-yl] pyridine-2-carboxylate, methyl 6-(1-acetyl-7-fluoro-1H-indol-6-yl)-4-amino-3-chloro-5-fluoropyridine-2-carboxylate, potassium 4-amino-3-chloro-5-fluoro-6-(7-fluoro-1H-indol-6-yl) pyridine-2-carboxylate, and butyl 4-amino-3-chloro-5-fluoro-6-(7-fluoro-1H-indol-6-yl) pyridine-2-carboxylate, salts and esters thereof, and mixtures thereof.

PS II inhibitors that can be used in the context of the present invention in addition as further herbicides include, for example, ametryn, amicarbazone, atrazine, bentazon, bromacil, bromoxynil, chlorotoluron, cyanazine, desmedipham, desmetryn, dimefuron, diuron, fluometuron, hexazinone, ioxynil, isoproturon, linuron, metamitron, methibenzuron, metoxuron, metribuzin, monolinuron, phenmedipham, prometon, prometryn, propanil, pyrazon, pyridate, siduron, simazine, simetryn, tebuthiuron, terbacil, terbumeton, terbuthylazine and trietazine, salts and esters thereof, and mixtures thereof, metribuzin being the preferred PS II inhibitor in the context of the present invention.

ALS and AHAS inhibitors include, for example, amidosulfuron, azimsulfruon, bensulfuron-methyl, bispyribac-sodium, chlorimuron-ethyl, chlorsulfuron, cinosulfuron, cloransulam-methyl, cyclosulfamuron, diclosulam, ethametsulfuron-methyl, ethoxysulfuron, flazasulfuron, florazulam, flucarbazone, flucetosulfuron, flumetsulam, flupyrsulfuron-methyl, foramsulfuron, halosulfuron-methyl, imazamethabenz, imazamox, imazapic, imazapyr, imazaquin, imazethapyr, imazosulfuron, iodosulfuron, metsulfuron-methyl, nicosulfuron, penoxsulam, primisulfuron-methyl, propoxycarbazone-sodium, prosulfuron, pyrazosulfuron-ethyl, pyribenzoxim, pyrithiobac, rimsulfuron, sulfometuron-methyl, sulfosulfuron, thiencarbazone, thifensulfuron-methyl, triasulfuron, tribenuron-methyl, trifloxysulfuron and triflusulfuron-methyl, salts and esters thereof, and mixtures thereof.

Mitosis inhibitors include anilofos, benefin, DCPA, dithiopyr, ethalfluralin,

flufenacet, mefenacet, oryzalin, pendimethalin, thiazopyr and trifluralin, salts and esters thereof, and mixtures thereof.

PPO inhibitors include, for example, acifluorfen, azafenidin, bifenox, butafenacil, carfentrazone-ethyl, epyrifenacil, flufenpyr-ethyl, flumiclorac, flumiclorac-pentyl, flumioxazin, fluoroglycofen, fluthiacet-methyl, fomesafen, lactofen, oxadiargyl, oxadiazon, oxyfluorfen, pyraflufen-ethyl, saflufenacil and sulfentrazone, salts and esters thereof, and mixtures thereof.

4-Hydroxyphenylpyruvate dioxygenase (HPPD) inhibitors and Carotenoid biosynthesis inhibitors that can be used in the context of the present invention as further herbicides include, for example, aclonifen, amitrole, beflubutamid, benzofenap, clomazone, diflufenican, fluridone, flurochloridone, flurtamone, isoxaflutole, norflurazon, picolinafen, pyrasulfotole, pyrazolynate, pyrazoxyfen, sulcotrione, tefuryltrione, tembotrione, tolpyralate and topramezone, salts and esters thereof, and mixtures thereof. diflufenican being the preferred carotenoid biosynthesis inhibitor in the context of the present invention.

PS I inhibitors include diquat and paraquat, salts and esters thereof, and mixtures thereof.

Cellulose inhibitors include dichlobenil and isoxaben.

An oxidative phosphorylation uncoupler is dinoterb, and esters thereof.

Auxin transport inhibitors include diflufenzopyr and naptalam. salts and esters thereof, and mixtures thereof.

Fatty acid and lipid biosynthesis inhibitors include bensulide, butylate, cycloate, EPTC, esprocarb, molinate, pebulate, prosulfocarb, thiobencarb, triallate and vernolate, salts and esters thereof, and mixtures thereof.

In certain embodiments, the further herbicide comprises at least one herbicide selected from the group consisting glyphosate, fomesafen, glufosinate, dicamba, 2,4-D. and salts thereof, and combinations thereof.

The auxin herbicide can preferably be selected from the group consisting of 2,4-D. 2,4-DB, dichloroprop, MCPA, MCPB, aminopyralid, clopyralid, fluroxypyr, triclopyr, diclopyr, mecoprop, dicamba, picloram and quinclorac, salts and esters thereof, and mixtures thereof.

In various embodiments, the further herbicide comprises a salt of dicamba such as an alkali metal salt or amine salt of dicamba. Specific examples of salts of dicamba include the sodium salt of dicamba, the potassium salt of dicamba, the monoethanolamine salt of dicamba, the diethanolamine salt of dicamba, the diglycolamine salt of dicamba, the dimethylamine salt of dicamba, the triethanolamine salt of dicamba, the choline salt of dicamba, the N,N-Bis(3-aminopropyl) methylamine salt of dicamba, and combinations thereof.

In these and other embodiments, the auxin herbicide can comprise a salt of 2,4-D such as an alkali metal salt or amine salt). Specific examples of salts of 2,4-D include the sodium salt of 2,4-D, the potassium salt of 2,4-D, the monoethanolamine salt of 2,4-D, the diethanolamine salt of 2,4-D, the diglycolamine salt of 2,4-D, the dimethylamine salt of 2,4-D, the triethanolamine salt of 2,4-D, the choline salt of 2,4-D, the N,N-Bis(3-aminopropyl) methylamine salt of 2,4-D, and combinations thereof.

The herbicide concentrate compositions of the present invention preferably additionally comprise as further constituent (d-1)—present in, and typically dissolved in, the water phase of the composition—one or more salts of auxin herbicides, preferably of dicamba or 2,4-D, wherein said salts preferably are alkali metal salts, preferably one or more potassium and/or sodium salts of auxin herbicides, particularly selected from the group consisting of potassium dicamba, sodium dicamba, potassium 2,4-D and sodium 2,4-D, and mixtures thereof.

The herbicide concentrate compositions of the present invention preferably additionally comprise as further constituent (d-1)—present in, and typically dissolved in, the water phase of the composition—one or more salts of dicamba or 2,4-D, wherein said salts preferably are selected from the group consisting of potassium dicamba, sodium dicamba, the triethanolamine salt of 2,4-D, and mixtures thereof.

If present, the total amount of constituent (d-1) in the herbicide concentrate compositions of the present invention on an acid equivalent basis is at least about 3.0 wt. %, preferably at least about 5.0 wt. %, in each case based on the total weight of the composition.

If present, the total amount of constituent (d-1) in the herbicide concentrate compositions of the present invention on an acid equivalent basis is in the range of from about 3.0 wt. % to about 20.0 wt. %, preferably in the range of from about 5.0 wt. % to about 15.0 wt. %, more preferably in the range of from about 7.5 wt. % to about 12.5 wt. %, in each case based on the total weight of the composition.

The herbicide concentrate compositions of the present invention preferably additionally comprise as further constituent (d-2)—present in the aqueous phase of the composition and/or in the core of the microcapsules comprising the acetamide herbicide, depending on the solubility of the respective constituent (d-2)—one or more further herbicides selected from the group consisting of 4-hydroxyphenylpyruvate dioxygenase (HPPD) inhibitor herbicides and carotenoid biosynthesis inhibitor herbicides, preferably selected from the group consisting of aclonifen, amitrole, beflubutamid, benzofenap, clomazone, diflufenican, fluridone, flurochloridone, flurtamone, isoxaflutole, norflurazon, picolinafen, pyrasulfotole, pyrazolynate, pyrazoxyfen, sulcotrione, tefuryltrione, tembotrione, tolpyralate and topramezone, salts and esters thereof, and mixtures thereof.

If present, the total amount of constituent (d-2) in the herbicide concentrate compositions of the present invention on an acid equivalent basis is at least about 1.0 wt. %, preferably at least about 1.5 wt. %, in each case based on the total weight of the composition.

If present, the total amount of constituent (d-2) in the herbicide concentrate compositions of the present invention on an acid equivalent basis is in the range of from about 1.0 wt. % to about 6.0 wt. %, preferably in the range of from about 1.5 wt. % to about 5.0 wt. %, more preferably in the range of from about 1.75 wt. % to about 4.0 wt. %, in each case based on the total weight of the composition.

In a preferred embodiment, constituent (d-2) comprises or consists of diflufenican.

In a preferred embodiment, constituent (d-2) comprises or consists of diflufenican wherein diflufenican is present in the water-immiscible core of the microcapsules of constituent (a) of the herbicide concentrate compositions of the present invention.

In a preferred embodiment, the present invention relates to a herbicide concentrate composition comprising:

(a) at least one particulate microcapsule comprising
a polymeric shell wall, and
a water-immiscible core material comprising (i) an acetamide herbicide and (ii) optionally one or more organic non-polar diluents,
wherein the total weight of the (i) acetamide herbicide is least about 5 wt. % of the total weight of the microcapsule,
   (b) a chelate of mesotrione and a divalent transition metal ion, wherein the molar ratio of the total amount of mesotrione and the total amount of the divalent transition metal ions expressed as molar ratio of mesotrione: divalent transition metal ions is greater than 2:1, based on the total amount of the herbicide concentrate composition, and
   (c) water in an amount of from about 20 wt. % to about 80 wt. %, based on the total weight of the herbicide concentrate composition,
   wherein the pH-value of the herbicide concentrate composition is 4.5 or lower when measured at 25° C. and 1013 mbar.

In a preferred embodiment, the present invention relates to a herbicide concentrate composition, preferably in the form of a ZC formulation, comprising:

(a) at least one particulate microcapsule comprising
a polymeric shell wall, and
a water-immiscible core material comprising (i) an acetamide herbicide and (ii) optionally one or more organic non-polar diluents,
wherein the total weight of the (i) acetamide herbicide is least about 10 wt. % of the total weight of the microcapsule, wherein the acetamide herbicide is selected from the group consisting of acetochlor, metolachlor, S-metolachlor, and combinations thereof,
   (b) a chelate of mesotrione and a divalent transition metal ion, wherein the molar ratio of the total amount of mesotrione and the total amount of the divalent transition metal ions expressed as molar ratio of mesotrione: divalent transition metal ions is in the range of from about 5:2 to about 8:2, based on the total amount of the herbicide concentrate composition, and wherein the total amount of (b) mesotrione on an acid equivalent basis is from about 1.0 wt. % to about 5.0 wt. %, based on the total weight of the herbicide concentrate composition,
   (c) water in an amount of from about 20 wt. % to about 80 wt. %, based on the total weight of the herbicide concentrate composition, and
   wherein the pH-value of the herbicide concentrate composition is in the range of from about 3.2 to about 4.2 when measured at 25° C. and 1013 mbar.

In a preferred embodiment, the present invention relates to a herbicide concentrate composition, preferably in the form of a ZC formulation, comprising:

(a) at least one particulate microcapsule comprising
a polymeric shell wall, and
a water-immiscible core material comprising (i) an acetamide herbicide and (ii) optionally one or more organic non-polar diluents,
wherein the total weight of the (i) acetamide herbicide is least about 10 wt. % of the total weight of the herbicide concentrate composition, wherein the acetamide herbicide is selected from the group consisting of acetochlor, metolachlor, S-metolachlor, and combinations thereof,
   (b) a chelate of mesotrione and a divalent transition metal ion, wherein the molar ratio of the total amount of mesotrione and the total amount of the divalent transition metal ions expressed as molar ratio of mesotrione: divalent transition metal ions is in the range of from about 5:2 to about 8:2, based on the total amount of the herbicide concentrate composition, and wherein the total amount of (b) mesotrione on an acid equivalent basis is from about 1.0 wt. % to about 5.0 wt. %, based on the total weight of the herbicide concentrate composition, and
   (c) water in an amount of from about 20 wt. % to about 80 wt. %, based on the total weight of the herbicide concentrate composition,
wherein the pH-value of the herbicide concentrate composition is in the range of from about 3.4 to about 4.0 when measured at 25° C. and 1013 mbar.

In a more preferred embodiment, the present invention relates to a herbicide concentrate composition in the form of a ZC formulation, comprising:

(a) at least one particulate microcapsule comprising
a polymeric shell wall, preferably a polyurea shell wall, and
a water-immiscible core material comprising (i) an acetamide herbicide and (ii) optionally one or more organic non-polar diluents,
wherein the total weight of the (i) acetamide herbicide is least about 10 wt. % of the total weight of the herbicide concentrate composition, wherein the acetamide herbicide is selected from the group consisting of acetochlor, metolachlor, S-metolachlor, and combinations thereof,
   (b) a chelate of mesotrione and a divalent transition metal ion, wherein the molar ratio of the total amount of mesotrione and the total amount of the divalent transition metal ions expressed as molar ratio of mesotrione: divalent transition metal ions is in the range of from about 5:2 to about 7:2, based on the total amount of the herbicide concentrate composition, wherein the total amount of (b) mesotrione on an acid equivalent basis is from about 1.5 wt. % to about 4.5 wt. %, based on the total weight of the herbicide concentrate composition,
   (c) water in an amount of from about 20 wt. % to about 80 wt. %, based on the total weight of the herbicide concentrate composition, and
   (d) optionally one or more further herbicide selected from the group
(d-1) consisting of salts of auxin herbicides, and
(d-2) consisting of aclonifen, amitrole, beflubutamid, benzofenap, clomazone, diflufenican, fluridone, flurochloridone, flurtamone, isoxaflutole, norflurazon, picolinafen, pyrasulfotole, pyrazolynate, pyrazoxyfen, sulcotrione, tefuryltrione, tembotrione, tolpyralate and topramezone, salts and esters thereof,
   wherein the pH-value of the herbicide concentrate composition is in the range of from about 3.4 to about 4.0 when measured at 25° C. and 1013 mbar.

In a particularly preferred embodiment, the present invention relates to a herbicide concentrate composition in the form of a ZC formulation, comprising:

(a) at least one particulate microcapsule comprising
a polyurea shell wall, and
a water-immiscible core material comprising (i) an acetamide herbicide and (ii) optionally one or more organic non-polar diluents,
wherein the total weight of the (i) acetamide herbicide is in the range of from about 10 wt. % to about 35 wt. % of the total weight of the herbicide concentrate composition,
wherein the acetamide herbicide comprises or consists of acetochlor,
   (b) a chelate of mesotrione and a divalent transition metal ion, wherein the molar ratio of the total amount of mesotrione and the total amount of the divalent transition metal ions expressed as molar ratio of mesotrione: divalent transition metal ions is in the range of from about 5:2 to about 6:2, based on the total amount of the herbicide concentrate composition, wherein the divalent transition metal ions are divalent copper ions (Cu²⁺), wherein the total amount of (b) mesotrione on an acid equivalent basis is from about 1.75 wt. % to about 4.0 wt. %, based on the total weight of the herbicide concentrate composition,
   (c) water in an amount of from about 30 wt. % to about 60 wt. %, based on the total weight of the herbicide concentrate composition, and
   (d) optionally one further herbicide selected from the group (d-1) consisting of potassium dicamba, sodium dicamba, potassium 2,4-D and sodium 2,4-D, and (d-2) diflufenican, wherein the pH-value of the herbicide concentrate composition is in the range of from about 3.4 to about 4.0, preferably in the range of from about 3.4 to about 3.8, when measured at 25° C. and 1013 mbar.

In a particularly preferred embodiment, the present invention relates to a herbicide concentrate composition in the form of a ZC formulation, comprising:

(a) at least one particulate microcapsule comprising
a polyurea shell wall, and
a water-immiscible core material comprising (i) an acetamide herbicide and (ii) optionally one or more organic non-polar diluents,
wherein the total weight of the (i) acetamide herbicide is in the range of from about 10 wt. % to about 35 wt. % of the total weight of the herbicide concentrate composition,
wherein the acetamide herbicide comprises or consists of acetochlor,
   (b) a chelate of mesotrione and a divalent transition metal ion, wherein the molar ratio of the total amount of mesotrione and the total amount of the divalent transition metal ions expressed as molar ratio of mesotrione: divalent transition metal ions is in the range of from about 5:2 to about 6:2, based on the total amount of the herbicide concentrate composition, wherein the divalent transition metal ions are divalent copper ions (Cu²⁺), wherein the total amount of (b) mesotrione on an acid equivalent basis is from about 1.75 wt. % to about 4.0 wt. %, based on the total weight of the herbicide concentrate composition,
   (c) water in an amount of from about 30 wt. % to about 60 wt. %, based on the total weight of the herbicide concentrate composition, and
   (d) optionally one further herbicide selected from the group (d-1) consisting of potassium dicamba, sodium dicamba, potassium 2,4-D and sodium 2,4-D, the triethanolamine salt of 2,4-D, and mixtures thereof,
wherein the pH-value of the herbicide concentrate composition is in the range of from about 3.4 to about 4.0, preferably in the range of from about 3.4 to about 3.8, when measured at 25° C. and 1013 mbar.

In a particularly preferred embodiment, the present invention relates to a herbicide concentrate composition in the form of a ZC formulation, comprising:

(a) at least one particulate microcapsule comprising
a polyurea shell wall, and
a water-immiscible core material comprising (i) an acetamide herbicide and (ii) optionally one or more organic non-polar diluents,
wherein the total weight of the (i) acetamide herbicide is in the range of from about 10 wt. % to about 35 wt. % of the total weight of the herbicide concentrate composition,
wherein the acetamide herbicide comprises or consists of acetochlor,
   (b) a chelate of mesotrione and a divalent transition metal ion, wherein the molar ratio of the total amount of mesotrione and the total amount of the divalent transition metal ions expressed as molar ratio of mesotrione: divalent transition metal ions is in the range of from about 5:2 to about 6:2, based on the total amount of the herbicide concentrate composition, wherein the divalent transition metal ions are divalent copper ions (Cu²⁺),
wherein the total amount of (b) mesotrione on an acid equivalent basis is from about 1.75 wt. % to about 4.0 wt. %, based on the total weight of the herbicide concentrate composition,
   (c) water in an amount of from about 30 wt. % to about 60 wt. %, based on the total weight of the herbicide concentrate composition,
   (d) one further herbicide selected from the group (d-1) consisting of potassium dicamba, sodium dicamba, potassium 2,4-D and sodium 2,4-D, the triethanolamine salt of 2,4-D, and mixtures thereof, and optionally (d-2) diflufenican,
wherein the pH-value of the herbicide concentrate composition is in the range of from about 3.4 to about 3.8, when measured at 25° C. and 1013 mbar.

In a particularly preferred embodiment, the present invention relates to a herbicide concentrate composition in the form of a ZC formulation, comprising:

(a) at least one particulate microcapsule comprising
a polyurea shell wall, and
a water-immiscible core material comprising (i) an acetamide herbicide and (ii) optionally one or more organic non-polar diluents,
wherein the total weight of the (i) acetamide herbicide is in the range of from about 10 wt. % to about 35 wt. % of the total weight of the herbicide concentrate composition,
wherein the acetamide herbicide comprises or consists of acetochlor,
   (b) a chelate of mesotrione and a divalent transition metal ion, wherein the molar ratio of the total amount of mesotrione and the total amount of the divalent transition metal ions expressed as molar ratio of mesotrione: divalent transition metal ions is in the range of from about 5:2 to about 6:2, based on the total amount of the herbicide concentrate composition, wherein the divalent transition metal ions are divalent copper ions (Cu²⁺),
wherein the total amount of (b) mesotrione on an acid equivalent basis is from about 1.75 wt. % to about 4.0 wt. %, based on the total weight of the herbicide concentrate composition,
   (c) water in an amount of from about 30 wt. % to about 60 wt. %, based on the total weight of the herbicide concentrate composition,
   (d) one further herbicide selected from the group (d-1) consisting of sodium dicamba or the triethanolamine salt of 2,4-D,
wherein the pH-value of the herbicide concentrate composition is in the range of from about 3.4 to about 3.8, when measured at 25° C. and 1013 mbar.

### Optional Further Constituents of the Herbicide Concentrate Compositions

The aqueous herbicide concentrate compositions of the present invention preferably are further formulated with one or more further adjuvants, formulation auxiliaries or additives customary in crop protection as described elsewhere herein (e.g., a stabilizer, one or more surfactants, an antifreeze, an anti-packing agent, drift control agents, etc.).

The aqueous herbicide concentrate compositions of the present invention may comprise one or more formulation adjuvants selected from anti-freezing agents, substances for controlling microorganism growth, and stabilizers to help physically stabilize the formulation and/or for controlling the formulation viscosity.

The herbicide concentrate compositions of the present invention can be formulated to further optimize its shelf stability and safe use. Dispersants, stabilizers, and thickeners are useful to inhibit the agglomeration and settling of the microcapsules. This function is facilitated by the chemical structure of these additives as well as by equalizing the densities of the aqueous and microcapsule phases. Anti-packing agents are useful when the microcapsules are to be redispersed. A pH buffer can be used to maintain the pH of the dispersion in a range which is safe for skin contact and, depending upon the additives selected, in a narrower pH range than may be required for the stability of the dispersion.

Low molecular weight dispersants may solubilize microcapsule shell walls, particularly in the early stages of their formation, causing gelling problems. Thus, in some embodiments dispersants having relatively high molecular weights of at least about 1.5 kg/mole, more preferably of at least about 3 kg/mol, and still more preferably at least about 5, 10 or even 15 kg/mole. In some embodiments, the molecular weight may range from about 3 kg/mole to about 50 kg/mole or from about 5 kg/mole to about 50 kg/mole. Dispersants may also be non-ionic or anionic. An example of a high molecular weight, anionic polymeric dispersant is polymeric naphthalene sulfonate sodium salt, such as Invalon (Huntsman Chemicals). Other useful dispersants and stabilizers include gelatin, casein, ammonium cascinate, polyvinyl alcohol, alkylated polyvinyl pyrrolidone polymers, maleic anhydride-methyl vinyl ether copolymers, styrene-maleic anhydride copolymers, maleic acid-butadiene and diisobutylene copolymers, ethylene oxide-propylene oxide block copolymers, sodium and calcium lignosulfonates, sulfonated naphthalene-formaldehyde condensates, modified starches, and modified cellulosics like hydroxyethyl or hydroxypropyl cellulose, sodium carboxy methyl cellulose, and fumed silica dispersions.

Thickeners are useful in retarding the settling process by increasing the viscosity of the aqueous phase. Shear-thinning thickeners may be preferred, because they act to reduce dispersion viscosity during pumping, which facilitates the economical application and even coverage of the dispersion to an agricultural field using the equipment commonly employed for such purpose. The viscosity of the microcapsule dispersion upon formulation may preferably range from about 100 cps to about 400 cps, as tested with a Haake Rotovisco Viscometer and measured at about 10°° C. by a spindle rotating at about 45 rpm. More preferably, the viscosity may range from about 100 cps to about 300 cps. A few examples of useful shear-thinning thickeners include water-soluble, guar-or xanthan-based gums (e.g. Kelzan from CPKelco), cellulose ethers (e.g. ETHOCEL from Dow), modified cellulosics and polymers (e.g. Aqualon thickeners from Hercules), and microcrystalline cellulose anti-packing agents.

Adjusting the density of the aqueous phase to approach the mean weight per volume of the microcapsules also slows down the settling process. In addition to their primary purpose, many additives may increase the density of the aqueous phase. Further increase may be achieved by the addition of sodium chloride, glycol, urea, or other salts. The weight to volume ratio of microcapsules of preferred dimensions is approximated by the density of the core material, where the density of the core material is from about 1.05 to about 1.5 g/cm³. Preferably, the density of the aqueous phase is formulated to within about 0.2 g/cm³ of the mean weight to volume ratio of the microcapsules. More preferably, the density of the aqueous phase ranges from about 0.2 g/cm³ less than the mean weight to volume ratio of the microcapsules to about equal to the mean weight to volume ratio of the microcapsules.

In order to enhance shelf stability and prevent gelling of aqueous dispersions of microcapsules, particularly upon storage in high temperature environments, the microcapsule dispersions may further include urea or similar structure-breaking agent at a concentration of up to about 20% by weight, typically about 5% by weight.

Surfactants can optionally be included in the herbicide compositions of the present invention. Suitable surfactants are selected from non-ionics, cationics, anionics, zwitterionics and mixtures thereof. Examples of surfactants suitable for the practice of the present invention include, but are not limited to: alkoxylated tertiary etheramines (such as TOMAH E-Series surfactants), alkoxylated quaternary etheramine (such as TOMAH Q-Series surfactant), alkoxylated etheramine oxides (such as TOMAH AO-Series surfactant), alkoxylated tertiary amine oxides (such as AROMOX series surfactants), alkoxylated tertiary amine surfactants (such as the ETHOMEEN T and C series surfactants), alkoxylated quaternary amines (such as the ETHOQUAD T and C series surfactants), alkyl sulfates, alkyl ether sulfates and alkyl aryl ether sulfates (such as the WITCOLATE series surfactants), alkyl sulfonates, alkyl ether sulfonates and alkyl aryl ether sulfonates (such as the WITCONATE series surfactants), lignin sulfonate (such as the REAX series) and alkoxylated phosphate esters and diesters (such as the PHOSPHOLAN series surfactants), alkyl polysaccharides (such as the AGRIMUL PG series surfactants), alkoxylated alcohols (such as the BRIJ or HETOXOL series surfactants), and mixtures thereof.

Anti-packing agents facilitate redispersion of microcapsules upon agitation of a formulation in which the microcapsules have settled. A microcrystalline cellulose material such as LATTICE from FMC is effective as an anti-packing agent. Other suitable anti-packing agents are, for example, clay, silicon dioxide, insoluble starch particles, and insoluble metal oxides (e.g. aluminum oxide or iron oxide). Anti-packing agents which change the pH of the dispersion are preferably avoided, for at least some embodiments.

Drift control agents suitable for the practice of the present invention are known to those skilled in the art and include the commercial products GARDIAN, GARDIAN PLUS, DRI-GARD, PRO-ONE XL ARRAY, COMPADRE, IN-PLACE, BRONC MAX EDT, EDT CONCENTRATE, COVERAGE and BRONC Plus Dry EDT.

Buffers such as disodium phosphate may be used to hold the pH in a range within which the components are most effective.

Other useful additives include, for example, biocides or preservatives (c.g., PROXEL®, commercially available from Avecia), antifreeze agents (such as glycerol, sorbitol, or urea), and antifoam agents (such as Antifoam SE23 from Wacker Silicones Corp. or Agnique® DFM-111S, a silicone based defoamer).

Herbicide concentrate compositions of the present invention containing acetamide herbicide(s), optionally one or more further herbicides in the core of microcapsules of constituent (a) and wherein the divalent metal chelated mesotrione of constituent (b) is the only herbicidal active ingredient in the water phase of the herbicide concentrate composition, typically the additives, adjuvants and/or formulation auxiliaries used to prepare said the herbicide concentrate composition include the ingredients for preparing microencapsulated acetamide herbicide [polymeric shell wall materials about 2.0-4.0 wt. %, Isopar M about 1.0-3.0 wt. %, emulsifier/dispersant REAX 105M about 1.0-1.5 wt. %, glycerin about 0.5-2.0 wt. %, ammonium cascinate about 0.08 wt. %, Invalon DAM about 1.5 wt. %, urea about 1.5-3.0 wt. %, disodium phosphate about 0.1-0.4 wt. %] as well as sodium hydroxide about 0.05-0.55 wt. % for adjusting the pH-value, stabilizer (Kelzan CC about 0.06 wt. %), preservative (Proxel GXL about 0.06 wt. %), antifoam agent (Agnique DFM-111S about 0.01-0.1 wt. %) and water for balance.

Herbicide concentrate compositions of the present invention containing acetamide herbicide(s), optionally one or more further herbicides in the core of microcapsules of constituent (a) and wherein water phase of the herbicide concentrate composition contains one or more further herbicidal active ingredients in addition to the divalent metal chelated mesotrione of constituent (b), typically the additives, adjuvants and/or formulation auxiliaries used to prepare said the herbicide concentrate composition include the ingredients for preparing microencapsulated acetamide herbicide [polymeric shell wall materials about 1.5-2.5 wt. %, Isopar M about 1.0-1.5 wt. %, emulsifier/dispersant REAX 105M about 1.0-1.5 wt. %, glycerin about 0.5-1.0 wt. %, ammonium caseinate about 0.06 wt. %, Invalon DAM about 1.0 wt. %, urea about 1.0-2.0 wt. %, disodium phosphate about 0.1-0.3 wt. %] as well as sodium hydroxide about 0.2-0.5 wt. % and/or sulfuric acid about 1.0-5.0 wt. % for adjusting the pH-value, stabilizer (Kelzan CC about 0.06 wt. %), preservative (Proxel GXL about 0.06 wt. %), antifoam agent (Agnique DFM-111S about 0.02-0.1 wt. %) and water for balance.

The aqueous herbicide concentrate compositions described herein can further comprise an additive to control or reduce potential herbicide volatility. Under some application conditions, certain herbicides such as auxin herbicides can, vaporize into the surrounding atmosphere and migrate from the application site to adjacent crop plants, where contact damage to sensitive plants can occur. For example, as described in US2014/0128264 and US2015/0264924, which are incorporated herein by reference, additives to control or reduce potential pesticide volatility include monocarboxylic acids, or salts thereof, e.g., acetic acid and/or an agriculturally acceptable salt thereof.

In preferred embodiments, in particular in case the herbicide concentrate compositions of the present invention comprise one or more auxin herbicides, a C₁-C₄ monocarboxylic acid and/or a salt thereof, preferably formic acid, acetic acid and/or alkali metal salts thereof, more preferably selected from the group consisting of formic gacid, acetic acid, potassium formate, sodium formate, potassium acetate and sodium acetate are present in the herbicide concentrate compositions of the present invention.

The total amount of C₁-C₄ monocarboxylic acids and salts thereof that is incorporated into the herbicide concentrate compositions of the present invention depends on the amount of (auxin) herbicides therein.

If present, the total amount of C₁-C₄ monocarboxylic acids and salts thereof in the herbicide concentrate compositions of the present invention is at least about 1.0 wt. %, preferably at least about 2.0 wt. %, in each case based on the total weight of the composition.

If present, the total amount of C₁-C₄ monocarboxylic acids and salts thereof in the herbicide concentrate compositions of the present invention is in the range of from about 3.0 wt. % to about 20.0 wt. %, preferably in the range of from about 4.0 wt. % to about 15.0 wt. %, often in the range of from about 5.0 wt. % to about 12.0 wt. %, in each case based on the total weight of the composition.

Preferably, the herbicide concentrate composition of the present invention comprises an aqueous phase, preferably an aqueous continuous phase.

The microcapsules used in the context of the present invention are dispersed in the herbicide concentrate composition of the present invention, preferably dispersed in the aqueous phase of the herbicide concentrate composition of the present invention.

Preferably, the herbicide concentrate composition of the present invention comprises one or more further adjuvants, formulation auxiliaries or additives customary in crop protection.

Preferably, the herbicide concentrate composition of the present invention comprises one or more further pesticides, preferably one or more further herbicides and/or one or more safeners.

Preferably, the herbicide concentrate composition of the present invention, preferably the aqueous phase of the composition, further comprises one or more emulsifiers.

Preferably, the herbicide concentrate composition of the present invention, preferably the aqueous phase of the composition, further comprises one or more formulation adjuvants, preferably selected from anti-freezing agents (such as urea, glycol and glycerin), substances for controlling microorganism growth (such as bactericides), and stabilizers to help physically stabilize the formulation and/or for controlling the formulation viscosity (such as natural or synthetic polymers such as Xanthan gum, guar gum, agar, carboxymethyl cellulose).

In a further aspect, the present invention relates to a spray application mixture (application mixture, tank-mix) obtainable or obtained by diluting a herbicide concentrate composition of the present invention with an appropriate amount of water, wherein preferably the ratio by weight of water to herbicide concentrate composition is in the range of from about 1:50 to about 1:10, preferably in the range of from about 1:40 to about 1:15, more preferably in the range of from about 1:30 to about 1:20.

Such as spray application mixture may comprise one or more further additives, formulation adjuvants and/or pesticides, preferably one or more further herbicides.

In a further aspect, the present invention relates to a method of making a spray application mixture of the present invention, characterized in that a herbicide concentrate composition is poured (slowly) into a water contained vessel under (mild) agitation, optionally including one or more further additives, formulation adjuvants and/or pesticides into the spray application mixture.

Preferably, in said method of making a spray application mixture of the present invention the amount of water used is such that the concentration of acetochlor in the resulting spray application mixture is in the range of from about 0.7% to about 1.5% by weight, preferably in the range of from about 0.9% to about 1.3% by weight.

Preferably, in said method of making a spray application mixture of the present invention the ratio by weight of water to herbicide concentrate composition is in the range of from about 1:50 to about 1:10, preferably in the range of from about 1:40 to about 1:15, more preferably in the range of from about 1:30 to about 1:20.

The spray application mixture may be applied to a field according to practices known to those skilled in the art. In some embodiments, the spray application mixture is applied to the soil, before planting the crop plants or after planting, but pre-emergent to the crop plants. Because the herbicidal active release characteristics of microcapsules used in the context of the present invention are adjustable, the timing of release initiation (or increase release) can be controlled thereby giving both commercially acceptable weed control and a commercially acceptable rate of crop injury.

The effective amount of microcapsules according to the present invention and optional further herbicide(s) to be applied to an agricultural field is to some extent dependent upon the identity of the co-herbicides, the release rate of the microcapsules, the crop to be treated, and environmental conditions, especially soil type and moisture. Generally, application rates of acetamide herbicides, such as, for example, acetochlor, are on the order of about 0.1, 0.5, 1, 2, 3, 4, 5, 6, 7, 8, 9 or 10 kilograms of herbicide per hectare, or ranges thereof, such as from 0.5 to 10 kilograms per hectare, from 0.5 to 10 kilograms per hectare, from 0.5 to 5 kilograms per hectare, or from 1 to 5 kilograms per hectare. In some embodiments, an application rate for sorghum, rice and wheat of from about 0.85 to about 1 kilogram per hectare is preferred. In preferred embodiments, typical application rates are about 1260 g/ha of acetochlor and 125 g/ha of mesotrione (ae), or about 630 g/ha of acetochlor and 63 g/ha of mesotrione (ae).

Generally, application rates of optional co-herbicides, such as, for example, dicamba, are on the order of about 0.05, 0.1, 0.5, 1, 1.5, 2, 2.5, 3, 4 or 5 kilograms of herbicide per hectare, or ranges thereof, such as from 0.1 to 5 kilograms per hectare, from 0.5 to 2.5 kilograms per hectare, or from 0.5 to 2 kilograms per hectare.

Application mixtures of the herbicide concentrate compositions are preferably applied to an agricultural field within a selected timeframe of crop plant development. In various embodiments of the present invention, the application mixture prepared from an aqueous herbicide concentrate is applied post-emergence to crop plants. For purposes of the present invention, post-emergence to crop plants includes initial emergence from the soil, i.e., “at cracking”. In some embodiments, the application mixture is applied to a field from 1-40 days prior to planting of the crop plant and/or pre-emergence (i.e., from planting of the crop plant up to, but not including, emergence or cracking) in order to provide control of newly emerging monocots and small seeded dicot species without significant crop damage. In various embodiments, the application mixture prepared from an aqueous herbicide concentrate of the present invention is applied pre-emergence to weeds.

Application mixtures of the herbicide concentrate compositions of the present

invention are useful for controlling a wide variety of weeds, i.e., plants that are considered to be a nuisance or a competitor of commercially important crop plants, such as corn, soybean, cotton, dry beans, snap beans, and potatoes etc. In some embodiments, the application mixtures are applied before the weeds emerge (i.e., pre-emergence application).

Monocotyledonous weeds belong, for example, to the genera Echinochloa, Setaria, Panicum, Digitaria, Phleum, Poa, Festuca, Eleusine, Brachiaria, Lolium, Bromus, Avena, Cyperus, Sorghum, Agropyron, Cynodon, Monochoria, Fimbristylis, Sagittaria, Eleocharis, Scirpus, Paspalum, Ischaemum, Sphenoclea, Dactyloctenium, Agrostis, Alopecurus and Apera.

Dicotyledonous weeds belong, for example, to the genera Sinapis, Lepidium, Galium, Stellaria, Matricaria, Anthemis, Galinsoga, Chenopodium, Urtica, Senecio, Amaranthus, Portulaca, Xanthium, Convolvulus, Ipomoca, Polygonum, Sesbania, Ambrosia, Kochia, Cirsium, Carduus, Sonchus, Solanum, Rorippa, Rotala, Lindernia, Lamium, Veronica, Abutilon, Emex, Datura, Viola, Galeopsis, Papaver, Centaurea, Trifolium, Ranunculus, Taraxacum and Euphorbia.

Examples of weeds that may be controlled according to the method of the present invention include, but are not limited to, Meadow Foxtail (Alopecurus pratensis) and other weed species with the Alopecurus genus, Common Barnyard Grass (Echinochloa crus-galli) and other weed species within the Echinochloa genus, crabgrasses within the genus Digitaria, White Clover (Trifolium repens), Lambsquarters (Chenopodium berlandieri), Redroot Pigweed (Amaranthus retroflexus) and other weed species within the Amaranthus genus, Proso millet (Panicum miliaceum) and other weed species of the Panicum spp., Common Purslane (Portulaca oleracea) and other weed species in the Portulaca genus, Chenopodium album and other Chenopodium spp., Setaria lutescens and other Setaria spp., Solanum nigrum and other Solanum spp., Lolium multiflorum and other Lolium spp., Brachiaria platyphylla and other Brachiaria spp., Sorghum halepense and other Sorghum spp., Conyza Canadensis and other Conyza spp., and Eleusine indica. In some embodiments, the weeds comprise one or more glyphosate-resistant species, 2,4-D-resistant species, dicamba-resistant species and/or ALS inhibitor herbicide-resistant species. In some embodiments, the glyphosate-resistant weed species is selected from the group consisting of Amaranthus palmeri, Amaranthus retroflexus, Amaranthus rudis, Amaranthus tamariscinus, Ambrosia artemisiifolia, Ambrosia trifida, Conyza bonariensis, Conyza canadensis, Digitaria insularis, Echinochloa colona, Eleusine indica, Euphorbia heterophylla, Lolium multiflorum, Lolium rigidum, Plantago lancelata, Sorghum halepense, Panicum miliaceum and Urochloa panicoides.

Certain crop plants such as soybean, cotton and corn are less susceptible to the action of acetamide herbicides and optional other co-herbicides such as dicamba than are weeds. In accordance with the present invention and based on experimental evidence to date, it is believed that the controlled acetamide release rate from the encapsulated acetamide herbicides in combination with crop plants having reduced acetamide susceptibility enables commercial control of weeds and commercially acceptable rates of crop damage when encapsulated acetamide herbicides are applied to a field either pre-planting or pre-emergent to the crop plant. This enables the use of seedling growth inhibitor acetamide herbicides, optionally seedling growth inhibitor acetamide herbicides in combination with a further herbicide such as dicamba, in crop plant pre-planting and pre-emergence applications.

In some embodiments of the present invention, crop plants include, for example, corn, soybean, cotton, dry beans, snap beans, and potatoes. Crop plants include hybrids, inbreds, and transgenic or genetically modified plants having specific traits or combinations of traits including, without limitation, herbicide tolerance (e.g., resistance to glyphosate, glufosinate, dicamba, sethoxydim, PPO inhibitor, etc.), Bacillus thuringiensis (Bt), high oil, high lysine, high starch, nutritional density, and drought resistance. In some embodiments, the crop plants are tolerant to organophosphorus herbicides, acetolactate synthase (ALS) or acetohydroxy acid synthase (AHAS) inhibitor herbicides, auxin herbicides and/or acetyl CoA carboxylase (ACCase) inhibitor herbicides. In other embodiments the crop plants are tolerant to glyphosate, dicamba, 2,4-D, MCPA, quizalofop, glufosinate and/or diclofop-methyl. In other embodiments, the crop plant is glyphosate and/or dicamba tolerant. In some embodiments of the present invention, crop plants are glyphosate and/or glufosinate tolerant. In some other embodiments, the crop plants are glyphosate, glufosinate and dicamba tolerant. In these or other embodiments, the crop plants are tolerant to PPO inhibitors.

Particularly preferred crop species are corn, cotton and soybean. In embodiments where the crop is corn, it is preferred to apply the application mixture at planting to before crop emergence, before planting of the crop (e.g., 1-4 weeks before planting crop), and/or after the crop has emerged. In embodiments where the crop is cotton, it is preferred to apply the application mixture at planting to before crop emergence, before planting of the crop (e.g., 1-4 weeks before planting crop), and/or after the crop has emerged (e.g., using a shielded sprayer to keep application mixture off of the crop). In embodiments where the crop is soybean, it is preferred to apply the application mixture at planting to before crop emergence, before planting of the crop (e.g., 1-4 weeks before planting crop), and/or after the crop has emerged.

Thus, the present invention also relates to a method for controlling undesired vegetation, in particular for controlling undesired vegetation in a field of a crop plant, the method comprising applying to the field a herbicidal composition of the present invention or a dilution thereof.

In the method for controlling undesired vegetation in a field of a crop plant, the crop plant preferably is selected from the group consisting of soybean, corn, canola, cotton, peanuts, potatoes, sugarbeets and/or wheat.

In the method for controlling undesired vegetation in a field of a crop plant, the crop plant preferably is soybean.

In the method for controlling undesired vegetation in a field of a crop plant, the crop plant preferably is corn.

In the method for controlling undesired vegetation, the application mixture preferably is applied to the field (i) prior to planting the crop plant or (ii) pre-emergence to the crop plant.

In the method for controlling undesired vegetation, the application mixture preferably is applied to the field post-emergence to the crop plant.

In the method for controlling undesired vegetation in a field of a crop plant, the crop plants have one or more herbicide tolerant traits.

The herbicidal compositions of the present invention or a dilution thereof were also found to be able to control difficult to control undesired vegetation (in a field of a crop plant).

The present invention therefore also relates to a method of applying to the field a herbicidal composition of the present invention or a dilution thereof, characterized in that it is carried out for difficult to control undesired vegetation (weeds or plants), in particular undesired vegetation (weeds or plants) having a resistance to one or more herbicides.

In another aspect, the method for controlling undesired vegetation is carried out for controlling weeds or plants having a resistance to herbicides of one, two, three, four, five or more different Modes of Action, wherein the resistances preferably are selected from the group consisting of auxin herbicide resistance, glyphosate resistance, acetolactate synthase (ALS) inhibitor resistance, 4-hydroxyphenylpyruvate dioxygenase (HPPD) inhibitor resistance, CoA carboxylase (ACCase) inhibitor resistance, photosystem I (PS I) inhibitor resistance, photosystem II (PS II) inhibitor resistance, protoporphyrinogen oxidase (PPO) inhibitor resistance, phytoene desaturase (PDS) inhibitor resistance and synthesis of very long-chain fatty acid (VLCFA) inhibitor resistance.

This applies particularly to undesired vegetation (weeds or plants) that are resistant to or are evolving resistance to one or to multiple Modes of Action, in particular resistance to one or more herbicides selected from the group consisting of glyphosate, auxin herbicides (auxins), ALS inhibitor herbicides, PSII inhibitor herbicides, HPPD inhibitor herbicides, PPO inhibitor herbicides and/or VLCFA inhibitor herbicides.

In one aspect, said method or use is carried out for controlling weeds or plants having a resistance to glyphosate.

In another aspect, said method or use is carried out for controlling weeds or plants having a resistance to glyphosate and one, two, three, four or more further resistances mentioned above, preferably selected from the group consisting of acetolactate synthase (ALS) inhibitor resistance, photosystem II (PS II) inhibitor resistance, 4-hydroxyphenylpyruvate dioxygenase (HPPD) inhibitor resistance, phytoene desaturase (PDS) inhibitor resistance and protoporphyrinogen oxidase (PPO) inhibitor resistance.

Examples of such resistant weeds include Amaranthus palmeri, Amaranthus tuberculatus, Kochia scoparia, Chenopodium album, Ambrosia trifida, Ambrosia artemisiifolia, Echinochloa crus-galli, Echinochloa colona, Lolium multiflorum and Eleusine indica.

Having described the invention in detail, it will be apparent that modifications and variations are possible without departing from the scope of the invention defined in the appended claims.

When introducing elements of the present invention or the preferred

embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above compositions and methods without departing from the scope of the invention, it is intended that all matter contained in the above description and shown in the accompanying drawings shall be interpreted as illustrative and not in a limiting sense.

### EXAMPLES

The following non-limiting examples are provided to further illustrate the present invention.

Unless indicated otherwise, all amounts and percentages are by weight.

### Abbreviations and Materials Used

ai: active ingredient

ae: acid equivalent

Agnique® DFM-111S=Aqueous solution based on hydrocarbons and modified organopolysiloxanes used as a defoamer (BASF)

Atlox® 4913=Atlox® 4913-LQ=Polymeric surfactant used as an emulsifying/dispersing agent (Croda)

Atlas® G-5002L=Polyalkylene oxide block copolymer used as an emulsifying or wetting agent (Croda)

Desmodur® N3215=Aliphatic Polyisocyanates (Covestro)

Isopar™M=Aliphatic solvent composed primarily of C₁₁-C₁₆ isoparaffinic hydrocarbons (isoalkanes), contains less than 2% of aromatics (ExxonMobil)

Invalon® DAM=Naphthalenesulfonic acid-formaldehyde condensate, Na salt (Huntsman Corporation)

Kelzan® CC=Xanthan gum (CP Kelco), used as 2% solution

Proxel® GXL=Preservative/antibacterial agent (Arch Chemicals)

Reax® 105M=Lignosulfate based dispersing agent (Ingevity)

SAG 1572=Silicone based antifoam emulsion (Momentive)

OptiXan™M 40=Emulsifier and thickener (Archer Daniels Midland Company)

Rocima™M BT 2s=19% benzisothiazolinone solubilized in dipropylene glycol, preservative (DuPont)

Aerodisp® 7520=Aerodisp® W 7520 N is a low viscosity, water-based dispersion of Aerosil® fumed silica, with a pH value 9.5-10.5 (SiO2 content about 20%) (Evonik)

TEA=Triethanolamine

Callisto®=Commercial product containing 40% of mesotrione (Syngenta)

RUP=Roundup PowerMax®, commercial product containing 39.8% (ae) of glyphosate (Bayer)

Warrant®=Commercial product containing 33% of acetochlor (Bayer)

XtendiMax®=Commercial product containing 29% (ae) of dicamba (Bayer)

Unless mentioned otherwise, AMATA and PANMI were glyphosate resistant

ABUTH=Abutilon theophrasti

AMAPA=Amaranthus palmeri

AMARE=Amaranthus retroflexus

AMATA=Amaranthus tamariscinus

CHEAL=Chenopodium album

PANMI=Panicum miliaceum

PESGL=Pennisetum glaucum

RCHSC=Richardia scabra

DAA: Days After Application

1/2X=0.5X=half rate, i.e. 50% of full recommended use rate

1X=full rate, i.e. full recommended use rate

2X=twice of full rate, i.e. double of full recommended use rate

GH=Green House

mol %=molar percent

wt %=Constituent weight percentage relative to the respective composition

### Preparation

### A. Mesotrione Mill Base

The mesotrione mill base was prepared as a concentrated suspension by grinding mesotrione dry (technical grade, 98%, Helm AG) to a desired particle size. The constituents shown in Table 1 below were charged in a container and thoroughly mixed to form a flowable dispersion. The dispersion was milled using a wet mill machine such as Eiger Mill (from EMI) to achieve a mean particle size in the range of about 5 μm to 6 μm.

TABLE 1
Composition of the Mesotrione mill base: ID 62104

| Constituent | wt % |
|---|---|
| Mesotrione (dry, technical grade) | 51.5% |
| Atlox ® 4913-LQ | 2.28% |
| Atlas ® G-5002L | 3.23% |
| SAG 1572 | 0.76% |
| OptiXan ™ 40/Rocima ™ BT 2s * | 5.15% |
| Water | 37.08% |

* OptiXan ™ 40/Rocima ™ BT 2s is mixture of 2.5% OptiXan ™ 40, 2.5% Rocima ™ BT 2s and 95% water

### B. Mesotrione Cu-chelate

Copper sulfate salt solution (24% Cu₂SO₄·5H₂O) was slowly added to the mesotrione mill base (Example A, Table 1). The solution was agitated at room temperature for at least 4 hours. The resulting mixture was a suspension of mesotrione Cu-chelate and the degree of chelation varied according to the mesotrione and Cu₂SO₄·5H₂O ratios used as shown in Table 2.

TABLE 2
Material balance for the different degrees
of Mesotrione copper chelation

| | 50 mol % | 75 mol % | 100 mol % |
|---|---|---|---|
| Constituent (in grams) | chelation | chelation | chelation |
| Mesotrione mill base (51.5% ae) | 100.0 | 100.0 | 100.0 |
| 24% Cu₂SO₄•5H₂O solution | 39.5 | 59.2 | 79.0 |

### C. 2-way Premixes of Microencapsulated Acetochlor and Cu-chelated Mesotrione

Microencapsulated acetochlor (Table 3-1, ID 301479) was prepared according to known methods. It was charged in a beaker and agitated using a magnet stirrer. The Cu-chelated mesotrione suspension was slowly added under agitation and continuously mixed for 5 minutes. Then, the respective amount of a 2% Kelzan® CC solution was added and mixed for 15 minutes. This was followed by dropwise addition of sodium hydroxide solution (10% or 20% NaOH in water) under agitation to adjust the mixture pH level. The suspension thus prepared was filtered using a No. 50 (US mesh standard) screen to remove any big particles.

### Examples of 2-way Premixes

Table 3 below depicts various 2-way formulations of microencapsulated acetochlor and mesotrione. The chemical stability measured at 40° C. for 8 weeks showed an acetochlor loss of less than 3% and a mesotrione loss of less than 5%.

TABLE 3
Examples of 2-way premixes

| | Constituents (in grams) | | | | | | | |
|---|---|---|---|---|---|---|---|---|
| | 2979-1 | 2979-2 | 2979-3 | 2979-4 | 2979-5 | 2979-6 | 2979-7 | 2979-8 |
| Microencapsulated | 153.00 | 173.80 | 153.00 | 153.01 | 153.00 | 153.02 | 86.60 | 76.10 |
| acetochlor (ID | | | | | | | | |
| 301479, 42% ai) | | | | | | | | |
| Mesotrione | — | — | — | — | 27.00 | 28.50 | 16.60 | — |
| (100 mol % copper | | | | | | | | |
| chelated) (25.0% ae) | | | | | | | | |
| Mesotrione (75 mol % | 21.30 | 25.50 | 23.70 | 25.10 | — | — | — | 11.80 |
| copper chelated) | | | | | | | | |
| (30.1% ae) | | | | | | | | |
| Sodium Hydroxide | — | — | — | — | — | — | 1.88 | 0.54 |
| (20%) | | | | | | | | |
| Sodium Hydroxide | 1.05 | 1.57 | 1.70 | 2.07 | 5.81 | 6.20 | — | — |
| (10%) | | | | | | | | |
| Kelzan ® CC (2%) | 3.27 | 3.74 | 3.25 | 3.29 | 3.28 | 3.27 | 2.00 | 2.05 |
| pH | 4.0 | 4.0 | 4.0 | 4.0 | 6.6 | 6.5 | 6.6 | 4.1 |

Active content by wt %

| | | | | | | | | |
|---|---|---|---|---|---|---|---|---|
| Acetochlor (%) | 35.96 | 35.67 | 35.37 | 35.02 | 33.97 | 33.64 | 33.96 | 35.41 |
| Mesotrione (%) | 3.60 | 3.75 | 3.93 | 4.12 | 3.58 | 3.74 | 3.88 | 3.85 |

Chemical stability after storage at 40° C. for 8 weeks (NT = Not tested)

| | | | | | | | | |
|---|---|---|---|---|---|---|---|---|
| Acetochlor loss (%) | 1.46 | 0.54 | 0.00 | 0.00 | 0.59 | NT | NT | NT |
| Mesotrione loss (%) | 4.19 | 3.74 | 2.83 | 2.97 | 0.00 | NT | NT | NT |

TABLE 3-1
Example of Microencapsulated Acetochlor
composition- ID 301479

| | wt % |
|---|---|
| Internal Phase | |
| Acetochlor (95.9%) | 43.8 |
| IsoparIM M | 2.26 |
| Desmodur ® N3215 | 3.2 |
| External Phase | |
| Reax ® 105M (40%) | 4 |
| Glycerin | 0.7 |
| Ammonium Caseinate | 0.1 |
| Agnique ® DFM-111S | 0.01 |
| Water | 35.75 |
| Triethylenetetramine | 1.44 |
| (50%) | |
| Stabilizer | |
| Invalon ® DAM (40%) | 3.6 |
| Urea (50%) | 3.8 |
| Glycerin | 0.5 |
| Agnique ® DFM-111S | 0.12 |
| Kelzan ® CC | 0.09 |
| Disodium phosphate | 0.5 |
| Proxel ® GXL | 0.13 |
| Total | 100 |

### D. 3-way Premixes of Microencapsulated Acetochlor, Dicamba and Cu-chelated Mesotrione Premixes

Microencapsulated acetochlor was charged in a beaker followed by addition of dicamba sodium salt solution. The mixture was agitated using a magnetic stirrer. Then, Cu-chelated mesotrione suspension was slowly added and continuously mixed for 5 minutes followed by addition of formic acid and sodium formate (and, if present, acetic acid and/or sodium acetate) and mixed well under agitation. In the next step, if present, the respective amount of a 2% Kelzan® CC solution was added and mixed for 15 minutes. Sodium hydroxide solution (10% or 20% in water), if used, was then added dropwise under agitation to adjust the mixture's pH value. If used, 50% sulfuric acid was added to adjust the pH value. The suspension thus prepared was filtered using a No. 50 (US mesh standard) screen to remove any big particles.

Tables 4-1 to 4-4 given below depict 3-way premixes and their corresponding chemical stability.

TABLE 4-1
Examples of 3-way premixes

| | Constituents (in grams) | | | | | |
|---|---|---|---|---|---|---|
| | 0775-20 | 0775-21 | 0775-22 | 0775-23 | 0775-24 | 0775-25 |
| Microencapsulated | 58.54 | 58.55 | 58.54 | 58.56 | 58.58 | 58.55 |
| acetochlor (42.0% ai) | | | | | | |
| Sodium dicamba solution | 22.75 | 22.74 | 22.75 | 22.76 | 22.75 | 22.74 |
| (48.0% ae) | | | | | | |
| Mesotrione suspension | 7.59 | 7.59 | 7.60 | 7.59 | 7.59 | 7.59 |
| (75 mol % copper chelated) | | | | | | |
| (32.4% ae) | | | | | | |
| Formic acid (95%) | 4.13 | 4.11 | 4.12 | 4.11 | 4.12 | 4.13 |
| Sodium formate (99.0%) | 3.92 | 4.99 | 5.74 | 8.36 | 8.47 | 11.24 |
| 2.5N NaOH | 4.16 | — | — | — | — | — |
| 50% H₂SO₄ | — | — | 2.3 | 4.8 | 6.42 | 9.32 |
| Water | 3.87 | 3.89 | 3.88 | 3.86 | 3.85 | 3.86 |
| pH | 3.8 | 3.8 | 3.6 | 3.6 | 3.4 | 3.4 |

Active content by wt %

| | | | | | | |
|---|---|---|---|---|---|---|
| Acetochlor (%) | 23.43 | 24.14 | 23.44 | 22.35 | 22.00 | 20.94 |
| Dicamba (% ae) | 10.41 | 10.73 | 10.42 | 9.93 | 9.78 | 9.31 |
| Mesotrione (%) | 2.34 | 2.41 | 2.34 | 2.23 | 2.20 | 2.09 |

Chemical stability after storage at 54° C. for 2 weeks

| | | | | | | |
|---|---|---|---|---|---|---|
| Acetochlor loss (%) | 3.5 | 1.74 | 3.84 | 3.47 | 1.87 | 2.6 |
| Dicamba loss (%) | 5.38 | 4.25 | 5.82 | 5.03 | 3.12 | 4.32 |
| Mesotrione loss (%) | 0.0 | 0.0 | 1.32 | 0.0 | 0.0 | 0.0 |

TABLE 4-2
Examples of 3-way premixes

| Constituents (in grams) | 0775-26 | 0775-27 | 0775-28 | 0775-29 |
|---|---|---|---|---|
| Microencapsulated | 59.23 | 58.55 | 59.71 | 58.55 |
| acetochlor (42.0% ai) | | | | |
| Sodium dicamba solution | 23.03 | 22.77 | 23.22 | 22.77 |
| (48% ae) | | | | |
| Mesotrione suspension | 7.68 | 7.59 | 7.74 | 7.59 |
| (75 mol % copper | | | | |
| chelated) (32.35% ae) | | | | |
| Formic acid (95%) | 4.13 | 4.12 | 4.13 | 4.13 |
| Sodium formate (99%) | 3.12 | 7.72 | 3.12 | 4.80 |
| Sodium acetate (98%) | 1.16 | — | 2.00 | — |
| 50% H2SO4 | — | 4.00 | 1.12 | — |
| Water | 2.80 | 3.85 | 2.08 | 3.84 |
| pH | 3.80 | 3.60 | 3.80 | 3.80 |

Active content by wt %

| | | | | |
|---|---|---|---|---|
| Acetochlor (%) | 24.59 | 22.65 | 24.32 | 24.19 |
| Dicamba (% ae) | 10.93 | 10.06 | 10.81 | 10.75 |
| Mesotrione (%) | 2.46 | 2.26 | 2.43 | 2.42 |

Chemical stability after storage at 54° C. for 1 week

| | | | | |
|---|---|---|---|---|
| Acetochlor loss (%) | 1.97 | 0.00 | 1.22 | 1.57 |
| Dicamba loss (%) | 2.79 | 1.39 | 2.74 | 2.97 |
| Mesotrione loss (%) | 1.65 | 0.44 | 0.00 | 1.65 |

TABLE 4-3
Examples of 3-way premixes

| | Constituents (in grams) | | | | | |
|---|---|---|---|---|---|---|
| | 1959-52 | 1959-54 | 1959-55 | 1959-56 | 1959-57 | 1959-59 |
| Microencapsulated | 51.30 | 51.00 | 66.18 | 51.30 | 51.30 | 51.00 |
| acetochlor (42.0% ai) | | | | | | |
| Sodium dicamba solution | 19.95 | 19.94 | 25.74 | 19.96 | 19.96 | 19.95 |
| (48% ae) | | | | | | |
| Mesotrione suspension | 7.14 | 7.16 | — | — | 7.17 | — |
| (75 mol % copper chelated | | | | | | |
| (30.1% ae) | | | | | | |
| Mesotrione (100 mol % | — | — | 9.70 | 7.59 | — | 7.48 |
| copper chelated | | | | | | |
| (28.76% ae) | | | | | | |
| Formic acid (95%) | 2.90 | 3.29 | 4.30 | 2.88 | 2.96 | 3.30 |
| Sodium formate (99%) | 4.03 | 3.42 | 5.12 | 4.08 | 3.94 | 3.60 |
| Acetic acid (99%) | — | 1.94 | — | — | — | 1.95 |
| Kelzan ® CC (2% | 1.20 | 1.09 | — | 1.66 | 1.04 | 1.10 |
| solution) | | | | | | |
| Water | — | — | 1.80 | 1.00 | 1.18 | — |
| Formulation pH | 3.78 | 3.76 | 3.8 | 3.76 | 3.78 | 3.8 |

Active content by wt %

| | | | | | | |
|---|---|---|---|---|---|---|
| Acetochlor (%) | 24.90 | 24.39 | 24.63 | 24.35 | 24.61 | 24.24 |
| Dicamba (% ae) | 11.07 | 10.90 | 10.95 | 10.83 | 10.94 | 10.84 |
| Mesotrione (%) | 2.48 | 2.45 | 2.47 | 2.47 | 2.47 | 2.43 |

Chemical stability after storage at 54° C. for 2 weeks

| | | | | | | |
|---|---|---|---|---|---|---|
| Acetochlor loss (%) | 3.61 | 4.01 | 2.80 | 2.73 | 2.94 | 3.17 |
| Dicamba loss (%) | 5.80 | 5.43 | 4.97 | 5.05 | 5.06 | 5.21 |
| Mesotrione loss (%) | 7.42 | 7.45 | 1.60 | 5.98 | 5.98 | 1.23 |

Chemical stability after storage at 40° C. for 8 weeks (NT = not tested)

| | | | | | | |
|---|---|---|---|---|---|---|
| Acetochlor loss (%) | NT | 2.11 | NT | 1.62 | NT | NT |
| Dicamba loss (%) | NT | 3.10 | NT | 3.31 | NT | NT |
| Mesotrione loss (%) | NT | 4..82 | NT | 2.83 | NT | NT |

### Table 4-4. Examples of 3-way Premixes With Direct Addition of CuSO₄

In the previous examples the copper chelated mesotrione was produced separately before incorporation into the respective premix. The following examples show the effect of a separate addition of copper salt during premix preparation on the chemical stability of the active ingredients in the respective formulation.

If the copper sulfate pentahydrate salt was added directly during preparation of the respective premix i.e. without separate or prior formation of the copper mesotrione chelate, it was found that the chemical stability of mesotrione can also be improved when an appropriate amount of a soluble copper salt was included directly into the respective mixture.

The examples were conducted by including the amount of copper sulfate CuSO₄·5H₂O (added as solid) indicated in the Table 4-4 into a the respective mixture containing microencapsulated acetochlor (used as Warrant®), dicamba Na-salt and mesotrione (used as mill base from Example A, Table 1).

| | Constituents (in grams) | | | | | |
|---|---|---|---|---|---|---|
| | 1002-1 | 1002-2 | 1002-3 | 1002-4 | 1002-5 | 1002-6 |
| Acetochlor (a.i.) | 25.30 | 25.83 | 25.53 | 25.63 | 25.07 | 25.27 |
| (Warrant ®) | | | | | | |
| Dicamba (% ae) | 10.96 | 11.20 | 11.06 | 11.16 | 10.91 | 11.00 |
| (sodium salt) | | | | | | |
| Mesotrione (mill | 2.46 | 2.48 | 2.45 | 2.47 | 2.42 | 2.43 |
| base; % ae) | | | | | | |
| Copper sulfate | 0.00 | 0.27 | 0.52 | 1.00 | 1.48 | 2.00 |
| (CuSO₄•5H₂O) (98%) | | | | | | |
| Cu²⁺/mesotrione | 0.00 | 0.14 | 0.28 | 0.54 | 0.81 | 1.10 |
| (molar ratio) | | | | | | |

### Chemical Stability After Storage at 54° C. for 1 week

| | | | | | | |
|---|---|---|---|---|---|---|
| Acetochlor loss (%) | 0 | 1.2 | 0 | 1.5 | 1.24 | 2.18 |
| Dicamba loss (% ae) | 0.91 | 2.32 | 0.63 | 1.80 | 2.29 | 3.55 |
| Mesotrione loss (% ae) | 15.85 | 14.80 | 7.35 | 0.81 | 0.00 | 1.23 |

### Chemical Stability After Storage at 40° C. for 8 weeks

| | | | | | | |
|---|---|---|---|---|---|---|
| Acetochlor loss (%) | 0.00 | 0.15 | 0.16 | 0.51 | 1.00 | 1.66 |
| Dicamba loss (% ae) | 0.46 | 0.98 | 0.54 | 1.61 | 1.65 | 2.36 |
| Mesotrione loss (% ae) | 6.91 | 6.45 | 5.31 | 0.00 | 0.41 | 0.82 |

The data show the chemical stability was improved significantly with the copper salt present in the premix. When the molar ratio of copper ions: mesotrione reached 0.54, the 3-way formulations displayed sufficient chemical stability. This effect is attributed to the copper chelation effect as the added Cu (II) ions react with mesotrione to form the copper chelate of mesotrione in-situ in the mixture.

### Effect of Degree of Cu-chelation on Mesotrione Stability

Table 4A below shows that mesotrione chemical stability has a linear relationship with the degree of Cu-chelation. Samples from Tables 1 and 2 above with 0 mol %, 50 mol %, 75 mol % and 100 mol % of Cu-chelation with pH 3.8 (adjusted using 20% sodium hydroxide solution in water) were utilized. The chemical stability was tested at 54° C. for 2 weeks and the chemical loss was obtained by comparing the aged samples with the respective samples stored at 0° C.

TABLE 4A
Mesotrione assay loss associated with
the molar degree of Cu-chelation.

| Degree of copper chelation (mol %) | Mesotrione loss (%) |
|---|---|
| 0 | 31.50 |
| 50 | 16.94 |
| 75 | 5.88 |
| 100 | 0.85 |

### Effects of Chelation and pH on the Stability of 2-way Premixes

As shown in Table 5, chemical stability measured at 54° C. for 2 weeks for both acetochlor and mesotrione increases with the reduction in pH and increase in degree of copper chelation.

TABLE 5
Assay for Mesotrione and Acetochlor
loss measured at 54° C. for 2 weeks

| Mesotrione Source | pH-value | Acetochlor (%) | Mesotrione (%) |
|---|---|---|---|
| 75 mol % Mesotrione | 2.9 | 0.0 | 5.71 |
| copper chelation | 4.1 | 0.37 | 6.85 |
| | 5.0 | 0.58 | 8.22 |
| | 6.0 | 0.78 | 8.64 |
| 100 mol % | 2.5 | 0.05 | 0.10 |
| Mesotrione copper | 3.9 | 0.22 | 0.38 |
| chelation | 5.1 | 0.31 | 1.14 |
| | 6.8 | 0.45 | 2.00 |

### Humidome Volatility Studies

Standard methods were used for humidome volatility studies. The results shown below in Table 6 depict comparative volatility for tank mixes of 3-way premixes and Roundup PowerMAX® (RUP) with the control.

TABLE 6
Volatility study for 3-way premixes

| | Normalized | pH-value |
|---|---|---|
| Formulation ID | Volatility | (spray solution) |
| Control (XtendiMax ®) + | 1.00 | 4.59-4.61 |
| Roundup PowerMax ®/RUP) | | |
| 0775-20 + RUP | 0.96 | 3.55 |
| 0775-21 + RUP | 0.81 | 3.68 |
| 0775-22 + RUP | 1.65 | 3.62 |
| 0775-23 + RUP | 0.81 | 3.51 |
| 0775-24 + RUP | 1.29 | 3.32 |
| 0775-28 + RUP | 1.28 | 3.50 |
| 0775-29 + RUP | 0.78 | 3.50 |
| 1959-54 + RUP | 0.85 | 3.57 |
| 1959-56 + RUP | 1.12 | 3.51 |

### Green House (GH) Studies

### Weed Efficacy for 2-way Premixes of Acetochlor and Mesotrione

Table 7 shows results for the green house weed efficacy study AMATA and PANMI for pre-emergent application. For both, at the 1/2X rate all premix formulations provided control equivalent to or better than the tank mix of Warrant® and Callisto®. At the 1X rate, all premixes provided >90% control of AMATA and PANMI.

TABLE 7
Pre-emergent weed control in GH for
the formulations described in Table 3

| | |
|---|---|
| AMATA (% | PANMI (% |
| control, average) | control, average) |

| | 1/2X | 1X | 1/2X | 1X |
|---|---|---|---|---|
| | usage | usage | usage | usage |
| Formulation ID | rate | rate | rate | rate |
| 2979-1 | 89.7 | 94.8 | 79.2 | 97.2 |
| 2979-2 | 96.7 | 98.3 | 91.3 | 99.7 |
| 2979-3 | 88.0 | 99.2 | 79.2 | 99.2 |
| 2979-4 | 97.2 | 97.5 | 85.8 | 98.0 |
| 2979-5 | 97.7 | 99.2 | 94.2 | 96.7 |
| 2979-6 | 96.3 | 100.0 | 91.7 | 97.5 |
| 2979-7 | 91.7 | 99.2 | 85.8 | 97.2 |
| 2979-8 | 88.8 | 97.5 | 68.3 | 92.2 |
| Control (Warrant ® | 83.3 | 100.0 | 69.7 | 98.0 |
| and Callisto ® | | | | |
| tank mix) | | | | |

### Crop Safety for 2-way Premixes of Acetochlor and Mesotrione

For evaluation of crop safety, several premixes were applied to mesotrione tolerant soybean, and the percent visual crop response was recorded at 13 DAA. Overall, the results generally indicate lower or equivalent injury when compared to the tank mixes as shown in Table 8.

TABLE 8
Soybean injury in GH from the formulations listed in Table 3

| Formulation ID | 1X usage rate | 2X usage rate |
|---|---|---|
| 2979-1 | 0.0 | 3.2 |
| 2979-2 | 1.0 | 2.0 |
| 2979-3 | 2.0 | 4.2 |
| 2979-4 | 2.0 | 4.2 |
| 2979-5 | 4.5 | 5.0 |
| 2979-6 | 3.6 | 4.0 |
| 2979-7 | 1.7 | 2.0 |
| 2979-8 | 1.1 | 1.1 |
| Control (Warrant ® and | 2.5 | 8.2 |
| Callisto ® tank mix) | | |

### Weed Efficacy for 3-way Premixes of microencapsulated Acetochlor, Dicamba and Cu-chelated Mesotrione

Depicted below in Table 9 are weed control efficacy studies in greenhouse on palmer amaranth (AMAPA) for 3-way premixes compared to the tank mix of Warrant®, XtendiMax® and Callisto®.

TABLE 9
Pre-emergent weed control in GH for the formulations described in Table 7

| | Control | | | | | | |
|---|---|---|---|---|---|---|---|
| | (Warrant ® + | | | | | | |
| | XtendiMax ® + | | | | | | |
| Weed | Callisto ® tank mix) | 1959-52 | 1959-54 | 1959-55 | 1959-56 | 1959-57 | 1959-59 |
| % | 96.6 | 97.5 | 95.8 | 94.2 | 98.3 | 95.8 | 90.8 |
| AMAPA | | | | | | | |
| control | | | | | | | |
| (21 DAA) | | | | | | | |

### Field Studies

For field experiments, formulations 1959-54 and 1959-56 were sprayed as pre-emergent and post-emergent application on bare ground soil. Table 10 shows the weed control efficacy for pre-emergent application rated at 28 and 42 days after application (DAA). Table 11 shows the weed control efficacy for post-emergent application rated at 14 and 21 DAA. The usage rates were 1258 g/ha for acetochlor, 620 g/ha for dicamba and 126 g/ha for mesotrione.

TABLE 10
Pre-emergent weed control in the field for the formulations described in Table 7

| | 28 DAA (% control) | | | | 42 DAA (% control) | | |
|---|---|---|---|---|---|---|---|
| Formulation ID | AMAPA | AMATA | CHEAL | PESGL | AMAPA | AMATA | CHEAL |
| 1959-56 | 100 | 94 | 100 | 93 | 91 | 89 | 100 |
| 1959-54 | 100 | 95 | 100 | 91 | 96 | 93 | 100 |
| Control | 100 | 97 | 100 | 80 | 93 | 93 | 100 |
| (Warrant ® and | | | | | | | |
| XtendiMax ® and | | | | | | | |
| Callisto ®) | | | | | | | |

TABLE 11
Post-emergent weed control in the field for the formulations described in Table 7

| | 14 DAA (% control) | | | | | 21 DAA (% control) | | | | |
|---|---|---|---|---|---|---|---|---|---|---|
| Formulation ID | ABUTH | AMAPA | AMARE | CHEAL | RCHSC | ABUTH | AMAPA | AMARE | CHEAL | RCHSC |
| 1959-56 | 100 | 85 | 94 | 82 | 98 | 100 | 89 | 98 | 100 | 100 |
| 1959-54 | 100 | 86 | 88 | 72 | 98 | 100 | 86 | 98 | 100 | 100 |
| Control (Warrant ® | 100 | 83 | 76 | 65 | 98 | 100 | 87 | 90 | 100 | 100 |
| and XtendiMax ® | | | | | | | | | | |
| and Callisto ®) | | | | | | | | | | |

### E. 3-way Premixes of Microencapsulated Acetochlor, 2,4-D and Cu-chelated Mesotrione Premixes

Microencapsulated acetochlor was charged in a beaker followed by addition of 2,4-D triethanolammonium salt solution. The mixture was agitated using a magnetic stirrer. Then, Cu-chelated mesotrione suspension was slowly added and continuously mixed for 5 minutes followed by addition of formic acid and mixed well under agitation. In the next step, the specified amount of Aerodisp® 7520N was added under agitation, and the respective amount of a 2% Kelzan® CC solution was added and mixed for 15 minutes. The suspension thus prepared was filtered using a No. 50 (US mesh standard) screen to remove any big particles.

Tables 12-1 and 12-2 given below depict 3-way premixes of the invention.

TABLE 12-1
Examples of 3-way premixes with 2,4-D

| Constituents (in grams) | 9261-1 | 9261-2 | 9261-3 | 9261-4 |
|---|---|---|---|---|
| Microencapsulated | 35.30 | 38.25 | 38.25 | 35.30 |
| acetochlor (52% ai) | | | | |
| 2,4-D TEA salt solution | 37.96 | 41.13 | 41.13 | 37.95 |
| (43% ae) | | | | |
| Mesotrione suspension | 5.84 | 6.31 | 6.31 | 5.84 |
| (75mol % copper chelated | | | | |
| (31.5% ae) | | | | |
| Aerodisp ® 7520 | 3.60 | 3.90 | 3.90 | 3.61 |
| Formic acid (95%) | 5.20 | 6.46 | 6.27 | 6.70 |
| Kelzan ® CC (2% | 3.60 | 3.28 | 3.91 | 3.71 |
| solution) | | | | |
| Water | 9.62 | 1.10 | 1.13 | 4.01 |
| Formulation pH | 3.63 | 3.59 | 3.60 | 3.60 |

Active content by wt %

| | | | | |
|---|---|---|---|---|
| Acetochlor (%) | 18.15 | 19.80 | 19.71 | 18.90 |
| 2,4-D (% ae) | 16.14 | 17.61 | 17.53 | 16.80 |
| Mesotrione (%) | 1.82 | 1.98 | 1.97 | 1.89 |

TABLE 12-2
Examples of 3-way premixes with 2,4-D

| Constituents (in grams) | 9651-1 | 9651-2 | 0253-1 | 0253-2 |
|---|---|---|---|---|
| Microencapsulated | 191.26 | 191.27 | 38.29 | 38.30 |
| acetochlor (52% ai) | | | | |
| 2,4-D TEA salt solution | 205.67 | 205.66 | — | — |
| (43% ae) | | | | |
| 2,4-D TEA salt solution | — | — | 50.55 | 50.60 |
| (35% ae) | | | | |
| Mesotrione suspension | 31.66 | 31.56 | 6.34 | 6.39 |
| (75 mol % copper chelated | | | | |
| (31.5% ae) | | | | |
| Aerodisp ® 7520 | 19.53 | 19.51 | 3.93 | 3.91 |
| Formic acid (95%) | 25.65 | 21.33 | 4.60 | 6.70 |
| Kelzan ® CC (2% solution) | 17.22 | 16.54 | 3.51 | 1.74 |
| Water | 10.80 | 16.00 | - | 2.79 |
| Formulation pH | 3.37 | 3.55 | 3.60 | 3.29 |

Active content by wt %

| | | | | |
|---|---|---|---|---|
| Acetochlor (%) | 19.82 | 19.82 | 18.57 | 18.03 |
| 2,4-D (% ae) | 17.62 | 17.62 | 16.50 | 16.04 |
| Mesotrione (%) | 1.98 | 1.98 | 1.86 | 1.82 |

### Chemical Stability After Storage at 54° C. for 2 Weeks

| | 9651-1 | 9651-2 |
|---|---|---|
| Acetochlor loss (%) | 4.60 | 5.20 |
| 2,4-D loss (% ae) | 5.30 | 6.10 |
| Mesotrione loss (% ae) | 0.80 | 1.20 |

### EMBODIMENTS

For further illustration, embodiments of the present invention are set forth below.

Embodiment lis a herbicide concentrate composition comprising:

(a) at least one particulate microcapsule comprising
a polymeric shell wall, and
a water-immiscible core material comprising (i) an acetamide herbicide and (ii) optionally one or more organic non-polar diluents,
wherein the total weight of the (i) acetamide herbicide is least about 5 wt. % of the total weight of the microcapsule,
   (b) a chelate of mesotrione and a divalent transition metal ion, wherein the molar ratio of the total amount of mesotrione and the total amount of the divalent transition metal ions expressed as molar ratio of mesotrione: divalent transition metal ions is greater than 2:1, based on the total amount of the herbicide concentrate composition, and
   (c) water.

Embodiment 2 is the composition of Embodiment 1, wherein the composition is a ZC formulation.

Embodiment 3 is the composition of Embodiment 1 or 2, wherein the total weight of (i) acetamide herbicide is at least about 10 wt. %, preferably at least about 15 wt. %, more preferably at least about 20 wt. %, even more preferably at least about 25 wt. %, and particularly preferably at least about 30 wt. %, in each case based on the total weight of the microcapsule of constituent (a).

Embodiment 4 is the composition of any one of Embodiments 1 to 3, wherein the (i) acetamide herbicide comprises at least one herbicide selected from the group consisting of acetochlor, alachlor, butachlor, butenachlor, delachlor, diethatyl and agriculturally acceptable esters thereof, dimethachlor, dimethenamid, dimethenamid-P, mefenacet, metazachlor, metolachlor, S-metolachlor, napropamide, pretilachlor, pronamide, propachlor, propisochlor, prynachlor, terbuchlor, thenylchlor and xylachlor, or agriculturally acceptable esters thereof, and combinations thereof.

Embodiment 4a is the composition of any one of Embodiments 1 to 3, wherein the acetamide herbicide is selected from the group consisting of acetochlor, alachlor, metolachlor, S-metolachlor, dimethenamid, dimethenamid-P, butachlor, and combinations thereof.

Embodiment 4b is the composition of any one of Embodiments 1 to 3, wherein the acetamide herbicide is selected from the group consisting of acetochlor, metolachlor, S-metolachlor, and combinations thereof.

Embodiment 5 is the composition of any one of Embodiments 1 to 4b, wherein the (i) acetamide herbicide comprises or consists of acetochlor.

Embodiment 6 is the composition of any one of Embodiments 1 to 5, wherein the microcapsules of constituent (a) are characterized as having a mean particle size range of from about 2 μm to about 15 μm, from about 2 μm to about 12 μm, from about 2 μm to about 10 μm, from about 2 μm to about 8 μm, from about 3 μm to about 15 μm, from about 3 μm to about 10 μm, from about 3 μm to about 8 μm, from about 4 μm to about 15 μm, from about 4 μm to about 12 μm, from about 4 μm to about 10 μm, from about 4 μm to about 8 μm, or from about 4 μm to about 7 μm.

Embodiment 7 is the composition of any one of Embodiments 1 to 6, wherein the microcapsules of constituent (a) are characterized as having a mean particle size range of from about 3 μm to about 9 μm,

Embodiment 8 is the composition of any one of Embodiments 1 to 7, wherein the total weight of the (i) acetamide herbicide is from about 10 wt. % to about 15 wt. %, from about 15 wt. % to about 20 wt. %, from about 20 wt. % to about 25 wt. %, from about 25 wt. % to about 30 wt. %, from about 30 wt. % to about 35 wt. %, from about 35 wt. % to about 40 wt. %, or from about 40 wt. % to about 45 wt. % of the microcapsules of constituent (a).

Embodiment 9 is the composition of any one of Embodiments 1 to 8, wherein the total weight of the (i) acetamide herbicide is at least about 10 wt. %, preferably at least about 15 wt. %, more preferably at least about 20 wt. %, in each case based on the total weight of the composition.

Embodiment 10 is the composition of any one of Embodiments 1 to 8, wherein the total weight of the (i) acetamide herbicide is in the range of from about 10.0 wt. % to about 35.0 wt. %, preferably in the range of from about 15.0 wt. % to about 30.0 wt. %, more preferably in the range of from about 20.0 wt. % to about 27.5 wt. %, in each case based on the total weight of the composition.

Embodiment 11 is the composition of any one of Embodiments 1 to 10, wherein the molar ratio of the total amount of mesotrione and the total amount of the divalent transition metal ions expressed as molar ratio of mesotrione: divalent transition metal ions is in the range of from about 5:2 to about 8:2, preferably in the range of from about 5:2 to about 7:2, more in the range of from about 5:2 to about 6:2, and even more preferably about 2:0.75, in each case based on the total weight of the herbicide concentrate composition.

Embodiment 12 is the composition of any one of Embodiments 1 to 11, wherein the total amount of (b) mesotrione on an acid equivalent basis is from about 1.0 wt. % to about 5.0 wt. %, preferably from about 1.5 wt. % to about 4.5 wt. %, more preferably from about 1.75 wt. % to about 4.0 wt. %, even more preferably from about 2.0 wt. % to about 3.5 wt. %, in each case based on the total weight of the composition.

Embodiment 12a is the composition of any one of Embodiments 1 to 12, wherein the ratio of the total weight of acetamide herbicides to the total weight of mesotrione on an acid equivalent (ae) basis, is in the range of from about 3:1 to about 20:1, preferably in the range of from about 4:1 to about 17:1, more preferably in the range of from about 5:1 to about 15:1, often in the range of from about 6:1 to about 12:1, such as about 10:1, in each case based on the total weight of the herbicide concentrate composition.

Embodiment 13 is the composition of any one of Embodiments 1 to 12a, wherein mesotrione is chelated by a divalent transition metal ion is present in solid form, wherein preferably the solid particles have an average particle size of from about 2 μm to about 12 μm, preferably of from about 3 μm to about 10 μm, more preferably of from about 4 um to about 9 μm, particularly preferably of from about 5 μm to about 8 μm.

Embodiment 14 is the composition of any one of Embodiments 1 to 13, wherein the divalent transition metal ions are divalent copper ions (Cu²⁺).

Embodiment 15 is the composition of any one of Embodiments 1 to 14, wherein the water content (constituent (c)) of the composition is in the range of from about 20 wt. % to about 80 wt. %, preferably in the range of from about 30 wt. % to about 60 wt. %, in each case based on the total weight of the composition.

Embodiment 16 is the composition of any one of Embodiments 1 to 15, wherein the pH-value of the herbicide concentrate composition is 4.5 or lower, preferably in the range of from about 3.2 to about 4.2, more preferably in the range of from about 3.4 to about 4.0, in each case when measured at 25° C. and 1013 mbar.

Embodiment 17 is the composition of any one of Embodiments 1 to 16, wherein the composition additionally comprises constituent (d-1) wherein constituent (d-1) comprises one or more salts of auxin herbicides, preferably of dicamba or 2,4-D, wherein said salts more preferably are selected from the group consisting of potassium dicamba, sodium dicamba, potassium 2,4-D, sodium 2,4-D, the triethanolamine salt of 2,4-D, and mixtures thereof.

Embodiment 18 is the composition of Embodiment 17, wherein the total amount of constituent (d-1) on an acid equivalent basis is at least about 3.0 wt. %, preferably at least about 5.0 wt. %, in each case based on the total weight of the composition.

Embodiment 19 is the composition of Embodiment 17, wherein the total amount of constituent (d-1) on an acid equivalent basis is in the range of from about 3.0 wt. % to about 20.0 wt. %, preferably in the range of from about 5.0 wt. % to about 15.0 wt. %, more preferably in the range of from about 7.5 wt. % to about 12.5 wt. %, in each case based on the total weight of the composition.

Embodiment 20 is the composition of any one of Embodiments 1 to 19, wherein the composition additionally comprises as further constituent (d-2), wherein constituent (d-2) comprises one or more further herbicides selected from the group consisting of 4-hydroxyphenylpyruvate dioxygenase (HPPD) inhibitor herbicides and carotenoid biosynthesis inhibitor herbicides, preferably selected from the group consisting of aclonifen, amitrole, beflubutamid, benzofenap, clomazone, diflufenican, fluridone, flurochloridone, flurtamone, isoxaflutole, norflurazon, picolinafen, pyrasulfotole, pyrazolynate, pyrazoxyfen, sulcotrione, tefuryltrione, tembotrione, tolpyralate and topramezone, salts and esters thereof, and mixtures thereof.

Embodiment 21 is the composition of Embodiment 20, wherein the total amount of constituent (d-2) on an acid equivalent basis is at least about 1.0 wt. %, preferably at least about 1.5 wt. %, in each case based on the total weight of the composition.

Embodiment 22 is the composition of Embodiment 20, wherein the total amount of constituent (d-2) on an acid equivalent basis is in the range of from about 1.0 wt. % to about 6.0 wt. %, preferably in the range of from about 1.5 wt. % to about 5.0 wt. %, more preferably in the range of from about 1.75 wt. % to about 4.0 wt. %, in each case based on the total weight of the composition.

Embodiment 23 is the composition of any one of Embodiments 1 to 22, wherein the composition comprises a C₁-C₄ monocarboxylic acid and/or a salt thereof, preferably formic acid, acetic acid and/or alkali metal salts thereof, more preferably selected from the group consisting of formic acid, acetic acid, potassium formate, sodium formate, potassium acetate and sodium acetate.

Embodiment 24 is the composition of any one of Embodiments 1 to 23, wherein the core material of the microcapsule comprises (ii) one or more organic non-polar diluents.

Embodiment 25 is the composition of any one of Embodiments 1 to 24, wherein the core material of the microcapsule comprises (ii) one or more organic non-polar diluents, wherein the ratio by weight of the total weight of the (i) acetamide herbicide to the total weight of the (ii) organic non-polar diluents in said microcapsule is in the range of from in the range of from 100:1 to 1:1, more preferably in the range of from 50:1 to 2:1.

Embodiment 26 is the composition of any one of Embodiments 1 to 25, wherein the polymeric shell wall of the microcapsule comprises or consists of organic polymers, preferably selected from the group consisting of polyurea, polyurethane, polycarbonate, polyamide, polyester and polysulfonamide, and mixtures thereof.

Embodiment 27 is the composition of any one of Embodiments 1 to 26, wherein the polymeric shell wall of the microcapsule is a polyurea shell wall formed in a polymerization medium by a polymerization reaction between a polyisocyanate component comprising a polyisocyanate or mixture of polyisocyanates and a polyamine component comprising a polyamine or mixture of polyamines to form the polyurea.

Embodiment 28 is the composition of Embodiment 27, wherein the polyisocyanate component comprises an aliphatic polyisocyanate.

Embodiment 29 is the composition of Embodiment 27 or 28, wherein the polyamine component comprises a polyamine of the structure NH₂(CH₂CH₂NH)ₘCH₂CH₂NH₂ where m is from 1 to 5, 1 to 3, or 2.

Embodiment 30 is the composition of any one of Embodiments 27 to 29, wherein the polyamine component is selected from the group consisting of substituted or unsubstituted polyethyleneamine, polypropyleneamine, diethylene triamine, triethylenetetramine (TETA), and combinations thereof, preferably the polyamine component is triethylenetetramine (TETA).

Embodiment 31 is the composition of any one of Embodiments 27 to 30, wherein the ratio of amine molar equivalents contained in the polyamine component to isocyanate molar equivalents contained in the polyisocyanate component is at least about 0.9:1, at least about 0.95:1, at least about 1:1, at least about 1.01:1, at least about 1.05:1, or at least about 1.1:1.

Embodiment 32 is the composition of any one of Embodiments 27 to 31, wherein the polyurea shell wall of the microcapsule is formed in a polymerization medium by a polymerization reaction between a polyisocyanate component comprising a polyisocyanate or mixture of polyisocyanates and a polyamine component comprising a polyamine or mixture of polyamines to form the polyurea and the ratio of amine molar equivalents contained in the polyamine component to isocyanate molar equivalents contained in the polyisocyanate component is from about from 1.01:1 to about 1.3:1, preferably from 1.01:1 to about 1.25:1, from 1.01:1 to about 1.2:1, from about 1.05:1 to about 1.3:1, from about 1.05:1 to about 1.25:1, from about 1.05:1 to about 1.2:1, from about 1.1:1 to about 1.3:1, from about 1.1:1 to about 1.25:1, and from about 1.1:1 to about 1.2:1.

Embodiment 33 is the composition of any one of Embodiments 1 to 32, wherein the composition comprises one or more further adjuvants, formulation auxiliaries or additives customary in crop protection.

Embodiment 34 is the composition of any one of Embodiments 1 to 33, wherein the composition comprises one or more formulation adjuvants selected from anti-freezing agents, substances for controlling microorganism growth, and stabilizers to help physically stabilize the formulation and/or for controlling the formulation viscosity.

Embodiment 35 is a method of manufacturing a herbicide concentrate composition according to of any one of Embodiments 1 to 34, wherein said method comprises the following steps:

(1) providing
(a) at least one particulate microcapsule comprising
a polymeric shell wall, and
a water-immiscible core material comprising (i) an acetamide herbicide and (ii) optionally one or more organic non-polar diluents,
wherein the total weight of the (i) acetamide herbicide is least about 5 wt. % of the total weight of the microcapsule,
(b-1) mesotrione solid particles have an average particle size of from about 2 μm to about 12 μm, preferably of from about 3 μm to about 10 μm, more preferably of from about 4 μm to about 9 μm, particularly preferably of from about 5 μm to about 8 μm,
(b-2) a salt of divalent transition metal ion,
wherein the molar ratio of the total amount of mesotrione and the total amount of the divalent transition metal ion salt as molar ratio of mesotrione:divalent transition metal ions is greater than 2:1,
(c) water,
(2) mixing the constituents provided in step (1).

Embodiment 36 is the method according to Embodiment 35, wherein the salt of divalent transition metal ion of constituent (b-2) is a water-soluble salt, preferably a water-soluble Cu(II)-salt, more preferably Cu(II) sulfate, in turn preferably in form of CuSO₄·5H₂O.

Embodiment 37 is a spray application mixture obtainable or obtained by diluting a composition of any one of Embodiments 1 to 34 with water, wherein the ratio by weight of water to herbicide concentrate composition is in the range of from about 1:50 to about 1:10, preferably in the range of from about 1:40 to about 1:15, more preferably in the range of from about 1:30 to about 1:20.

Embodiment 38 is the spray application mixture of Embodiment 37, wherein the spray application mixture comprises one or more further additives, formulation adjuvants and/or pesticides, preferably one or more further herbicides.

Embodiment 39 is a method of making the spray application mixture of Embodiment 37 or 38, wherein the herbicide concentrate composition of any one of Embodiments 1 to 34, and optionally one or more further additives, formulation adjuvants and/or pesticides, are poured into a water contained vessel under agitation.

Embodiment 40 is the method according to Embodiment 39, wherein the amount of water used is such that the concentration of acetamide herbicide, preferably of Embodiment 4b, more preferably of acetochlor, in the resulting spray application mixture is in the range of from about 0.7% to about 1.5% by weight, preferably in the range of from about 0.9% to about 1.3% by weight.

Embodiment 41 is the method according to Embodiment 39, wherein the ratio by weight of water to herbicide concentrate composition is in the range of from about 1:50 to about 1:10, preferably in the range of from about 1:40 to about 1:15, more preferably in the range of from about 1:30 to about 1:20.

Embodiment 42 is a method for controlling undesired vegetation, preferably in a field of a crop plant, the method comprising applying to the field a composition as defined in any one of Embodiments 1 to 34 or a spray application mixture as defined in Embodiments 37 or 38.

Embodiment 43 is the method of Embodiment 42, wherein the crop plant is selected from the group consisting of soybean, corn, canola, cotton, peanuts, potatoes, sugarbeets and/or wheat.

Embodiment 44 is the method of Embodiment 43, wherein the crop plant is soybean.

Embodiment 45 is the method of Embodiment 43, wherein the crop plant is cotton.

Embodiment 46 is the method of any one of Embodiments 42 to 45, wherein the composition is applied to the field (i) prior to planting the crop plant or (ii) pre-emergence to the crop plant.

Embodiment 47 is the method of any one of Embodiments 42 to 45, wherein the composition is applied to the field post-emergence to the crop plant.

Embodiment 48 is the method of any one of Embodiments 42 to 47, wherein the crop plants have one or more herbicide tolerant traits.

Embodiment 49 is the method of any one of Embodiments 42 to 48, wherein the method is carried out for controlling difficult to control weeds or plants.\

Embodiment 50 is the method of any one of Embodiments 42 to 49, wherein the method is carried out for controlling weeds or plants having a resistance to herbicides of one, two, three, four, five or more different Modes of Action, wherein the resistances preferably are selected from the group consisting of auxin herbicide resistance, glyphosate resistance, acetolactate synthase (ALS) inhibitor resistance, 4-hydroxyphenylpyruvate dioxygenase (HPPD) inhibitor resistance, CoA carboxylase (ACCase) inhibitor resistance, photosystem I (PS I) inhibitor resistance, photosystem II (PS II) inhibitor resistance, protoporphyrinogen oxidase (PPO) inhibitor resistance, phytoene desaturase (PDS) inhibitor resistance and synthesis of very long-chain fatty acid (VLCFA) inhibitor resistance.

1. A herbicide concentrate composition comprising:
(a) at least one particulate microcapsule comprising
a polymeric shell wall, and
a water-immiscible core material comprising (i) an acetamide herbicide and (ii) optionally one or more organic non-polar diluents,
wherein the total weight of the (i) acetamide herbicide is least about 5 wt. % of the total weight of the microcapsule,
(b) a chelate of mesotrione and a divalent transition metal ion, wherein the molar ratio of the total amount of mesotrione and the total amount of the divalent transition metal ions expressed as molar ratio of mesotrione: divalent transition metal ions is greater than 2:1, based on the total amount of the herbicide concentrate composition, and
(c) water.

2. The composition of claim 1, wherein the composition is a ZC formulation.

3. The composition of claim 1, wherein the total weight of (i) acetamide herbicide is at least about 10 wt. %, based on the total weight of the microcapsule of constituent (a).

4. The composition of claim 1, wherein the (i) acetamide herbicide comprises at least one herbicide selected from the group consisting of acetochlor, alachlor, butachlor, butenachlor, delachlor, diethatyl and agriculturally acceptable esters thereof, dimethachlor, dimethenamid, dimethenamid-P, mefenacet, metazachlor, metolachlor, S-metolachlor, napropamide, pretilachlor, pronamide, propachlor, propisochlor, prynachlor, terbuchlor, thenylchlor and xylachlor, or agriculturally acceptable esters thereof, and combinations thereof.

5. The composition of claim 1, wherein the microcapsules of constituent (a) are characterized as having a mean particle size range of from about 2 μm to about 15 μm.

6. The composition of claim 1, wherein the total weight of the (i) acetamide herbicide is at least about 10 wt. %, based on the total weight of the composition.

7. The composition of claim 1, wherein the molar ratio of the total amount of mesotrione and the total amount of the divalent transition metal ions expressed as molar ratio of mesotrione: divalent transition metal ions is in the range of from about 5:2 to about 8:2, based on the total weight of the herbicide concentrate composition.

8. The composition of claim 1, wherein the total amount of (b) mesotrione on an acid equivalent basis is from about 1.0 wt. % to about 5.0 wt. %, based on the total weight of the composition.

9. The composition of claim 1, wherein mesotrione is chelated by a divalent transition metal ion is present in solid form, wherein the solid particles have an average particle size of from about 2 μm to about 12 μm.

10. The composition of claim 1, wherein the divalent transition metal ions are divalent copper ions (Cu²⁺).

11. The composition of claim 1, wherein the water content (constituent (c)) of the composition is in the range of from about 20 wt. % to about 80 wt. %, based on the total weight of the composition.

12. The composition of claim 1, wherein the pH-value of the herbicide concentrate composition is 4.5 or lower, when measured at 25° C. and 1013 mbar.

13. The composition of claim 1, wherein the composition additionally comprises constituent (d-1) wherein constituent (d-1) comprises one or more salts of auxin herbicides, preferably of dicamba or 2,4-D, wherein said salts more preferably are selected from the group consisting of potassium dicamba, sodium dicamba, potassium 2,4-D, sodium 2,4-D, the tricthanolamine salt of 2,4-D, and mixtures thereof, wherein the total amount of constituent (d-1) on an acid equivalent basis preferably is in the range of from about 3.0 wt. % to about 20.0 wt. %, based on the total weight of the composition.

14. The composition of claim 1, wherein the composition additionally comprises as further constituent (d-2), wherein constituent (d-2) comprises one or more further herbicides selected from the group consisting of 4-hydroxyphenylpyruvate dioxygenase (HPPD) inhibitor herbicides and carotenoid biosynthesis inhibitor herbicides, preferably selected from the group consisting of aclonifen, amitrole, beflubutamid, benzofenap, clomazone, diflufenican, fluridone, flurochloridone, flurtamone, isoxaflutole, norflurazon, picolinafen, pyrasulfotole, pyrazolynate, pyrazoxyfen, sulcotrione, tefuryltrione, tembotrione, tolpyralate and topramczone, salts and esters thereof, and mixtures thereof.

15. The composition of claim 1, wherein the composition comprises a C₁-C₄ monocarboxylic acid and/or a salt thereof, preferably formic acid, acetic acid and/or alkali metal salts thereof, more preferably selected from the group consisting of formic acid, acetic acid, potassium formate, sodium formate, potassium acetate and sodium acetate.

16. A method of manufacturing a herbicide concentrate composition of claim 1, wherein said method comprises the following steps:
(1) providing
(a) at least one particulate microcapsule comprising
a polymeric shell wall, and
a water-immiscible core material comprising (i) an acetamide herbicide and (ii) optionally one or more organic non-polar diluents,
wherein the total weight of the (i) acetamide herbicide is least about 5 wt. % of the total weight of the microcapsule,
(b-1) mesotrione solid particles have an average particle size of from about 2 μm to about 12 μm,
(b-2) a salt of divalent transition metal ion,
wherein the molar ratio of the total amount of mesotrione and the total amount of the divalent transition metal ion salt as molar ratio of mesotrione: divalent transition metal ions is greater than 2:1,
(c) water,
(2) mixing the constituents provided in step (1).

17. Spray application mixture obtainable or obtained by diluting a composition of claim 1 with water.

18. A method of making the spray application mixture of claim 17, wherein the herbicide concentrate composition of claim 1, and optionally one or more further additives, formulation adjuvants and/or pesticides, are poured into a water containing vessel under agitation.

19. A method for controlling undesired vegetation, preferably in a field of a crop plant, wherein said crop plant preferably is selected from the group consisting of soybean, corn, canola, cotton, peanut, potatoe, sugarbeet or wheat, the method comprising applying to the field a composition as defined in claim 1.

20. A method for controlling undesired vegetation, preferably in a field of a crop plant, wherein said crop plant preferably is selected from the group consisting of soybean, corn, canola, cotton, peanut, potatoe, sugarbeet or wheat, the method comprising applying to the field a spray application mixture as defined in claim 17.
